(19) United States
(12) Patent Application Publication
(10) Pub. No.: US 2024/0422630 A1
(43) Pub. Date: Dec. 19, 2024

(54) CAPABILITY INFORMATION REPORTING METHOD, RECEIVING METHOD, TERMINAL, DEVICE, AND STORAGE MEDIUM

(71) Applicant: VIVO MOBILE COMMUNICATION CO., LTD., Guangdong (CN)

(72) Inventors: Can LI, Guangdong (CN); Siqi LIU, Guangdong (CN)

(73) Assignee: VIVO MOBILE COMMUNICATION CO., LTD., Guangdong (CN)

(21) Appl. No.: 18/820,441

(22) Filed: Aug. 30, 2024

Related U.S. Application Data
(63) Continuation of application No. PCT/CN2023/077673, filed on Feb. 22, 2023.

(30) Foreign Application Priority Data
Mar. 1, 2022 (CN) 202210194644.3

(51) Int. Cl. H04W 36/00; H04L 27/26; H04W 72/0453

(52) U.S. Cl. CPC H04W 36/0058; H04L 27/26025; H04W 72/0453

(57) ABSTRACT

A capability information reporting method, a capability information receiving method, a terminal, a device, and a storage medium. The capability information reporting method in embodiments of this application includes: reporting, by a terminal, capability information related to Tx switching, where the capability information includes at least one of the following: a capability of supporting parallel Tx switching; a capability of supporting serial Tx switching; and a maximum number of switching periods within a preset period.

### CROSS-REFERENCE TO RELATED APPLICATIONS

This application is a continuation of International Application No. PCT/CN2023/077673 filed on Feb. 22, 2023, which claims priority to Chinese Patent Application No. 202210194644.3 filed on Mar. 1, 2022, which are incorporated herein by reference in their entireties.

### TECHNICAL FIELD

This application pertains to the field of communication technologies, and specifically relates to a capability information reporting method, a capability information receiving method, a terminal, a device, and a storage medium.

### BACKGROUND

In standard formulation of some communication systems (for example, a fifth-generation mobile communication technology (5G) or sixth-generation mobile communication technology (6G) system), a mechanism of transmitter switching (Tx switching, TransmitX switching) is being discussed in the communication systems, for example, a mechanism of uplink Tx switching (UL Tx switching). However, it is not clear how to report related information of Tx switching of the terminal, and therefore Tx switching of the terminal is affected, resulting in relatively poor transmission performance of the terminal.

### SUMMARY

According to a first aspect, a capability information reporting method is provided, including:
reporting, by a terminal, capability information related to Tx switching, where the capability information includes at least one of the following:
a capability of supporting parallel Tx switching;
a capability of supporting serial Tx switching; and
a maximum number of times of switching within a preset period.

According to a second aspect, a capability information receiving method is provided, including:

receiving, by a communication device, capability information that is related to Tx switching and that is reported by a terminal, where the capability information includes at least one of the following:
a capability of supporting parallel Tx switching;
a capability of supporting serial Tx switching; and
a maximum number of times of switching within a preset period.

According to a third aspect, a capability information reporting apparatus is provided, including:
a reporting module, configured to report capability information related to Tx switching, where the capability information includes at least one of the following:
a capability of supporting parallel Tx switching;
a capability of supporting serial Tx switching; and
a maximum number of times of switching within a preset period.

According to a fourth aspect, a capability information receiving apparatus is provided, including:
a receiving module, configured to receive capability information that is related to Tx switching and that is reported by a terminal, where the capability information includes at least one of the following:
a capability of supporting parallel Tx switching;
a capability of supporting serial Tx switching; and
a maximum number of times of switching within a preset period.

According to a fifth aspect, a terminal is provided, including a processor and a memory. The memory stores a program or an instruction that can be run on the processor, and the program or the instruction is executed by the processor to implement the steps of the capability information reporting method provided in the embodiments of this application.

According to a sixth aspect, a terminal is provided, including a processor and a communication interface. The communication interface is configured to report capability information related to Tx switching, where the capability information includes at least one of the following: a capability of supporting parallel Tx switching; a capability of supporting serial Tx switching; and a maximum number of times of switching within a preset period.

According to a seventh aspect, a communication device is provided, including a processor and a memory. The memory stores a program or an instruction that can be run on the processor, and the program or the instruction is executed by the processor to implement the steps of the capability information receiving method provided in the embodiments of this application.

According to an eighth aspect, a communication device is provided, including a processor and a communication interface. The communication interface is configured to receive capability information that is related to Tx switching and that is reported by a terminal, where the capability information includes at least one of the following: a capability of supporting parallel Tx switching; a capability of supporting serial Tx switching; and a maximum number of times of switching within a preset period.

According to a ninth aspect, a capability information transmission system is provided, including a terminal and a communication device. The terminal may be configured to perform the steps of the capability information reporting method according to the first aspect, and the communication device may be configured to perform the steps of the capability information receiving method according to the second aspect.

According to a tenth aspect, a readable storage medium is provided. The readable storage medium stores a program or an instruction, and the program or the instruction is executed by a processor to implement the steps of the capability information reporting method provided in the embodiments of this application, or the program or the instruction is executed by a processor to implement the steps of the capability information receiving method provided in the embodiments of this application.

According to an eleventh aspect, a chip is provided. The chip includes a processor and a communication interface, the communication interface is coupled to the processor, and the processor is configured to run a program or an instruction to implement the method according to the first aspect or the method according to the second aspect.

According to a twelfth aspect, a computer program product is provided. The computer program product is stored in a storage medium, and the computer program product is executed by at least one processor to implement the capability information reporting method according to the first aspect, or the computer program product is executed by at least one processor to implement the capability information receiving method according to the second aspect.

### BRIEF DESCRIPTION OF DRAWINGS

FIG. 1 is a block diagram of a wireless communication system to which the embodiments of this application are applicable;

FIG. 2 is a flowchart of a capability information reporting method according to an embodiment of this application;

FIG. 3 is a flowchart of a capability information receiving method according to an embodiment of this application;

FIG. 4 is a structural diagram of a capability information reporting apparatus according to an embodiment of this application;

FIG. 5 is a structural diagram of a capability information receiving apparatus according to an embodiment of this application;

FIG. 6 is a structural diagram of a communication device according to an embodiment of this application;

FIG. 7 is a structural diagram of a terminal according to an embodiment of this application; and

FIG. 8 is a structural diagram of a communication device according to an embodiment of this application.

### DETAILED DESCRIPTION

The following clearly describes the technical solutions in the embodiments of this application with reference to the accompanying drawings in the embodiments of this application. Apparently, the described embodiments are some but not all of the embodiments of this application. All other embodiments obtained by a person of ordinary skill based on the embodiments of this application shall fall within the protection scope of this application.

In the specification and claims of this application, the terms “first”, “second”, and the like are intended to distinguish between similar objects but do not describe a specific order or sequence. It should be understood that the terms used in such a way are interchangeable in proper circumstances so that the embodiments of this application can be implemented in orders other than the order illustrated or described herein. Objects classified by “first” and “second” are usually of a same type, and the number of objects is not limited. For example, there may be one or more first objects. In addition, in the specification and claims, “and/or” represents at least one of connected objects, and a character “/” generally represents an “or” relationship between associated objects.

It should be noted that technologies described in the embodiments of this application are not limited to a Long Time Evolution (LTE)/LTE-Advanced (LTE-A) system, and may further be applied to other wireless communication systems such as Code Division Multiple Access (CDMA), Time Division Multiple Access (TDMA), Frequency Division Multiple Access (FDMA), Orthogonal Frequency Division Multiple Access (OFDMA), single-carrier frequency division multiple access (SC-FDMA), and other systems. The terms “system” and “network” in the embodiments of this application may be used interchangeably. The technologies described can be applied to both the systems and the radio technologies mentioned above as well as to other systems and radio technologies. The following describes a New Radio (New Radio, NR) system for example purposes, and NR terms are used in most of the following descriptions. These technologies can also be applied to applications other than an NR system application, such as a 6th generation (6G) communication system.

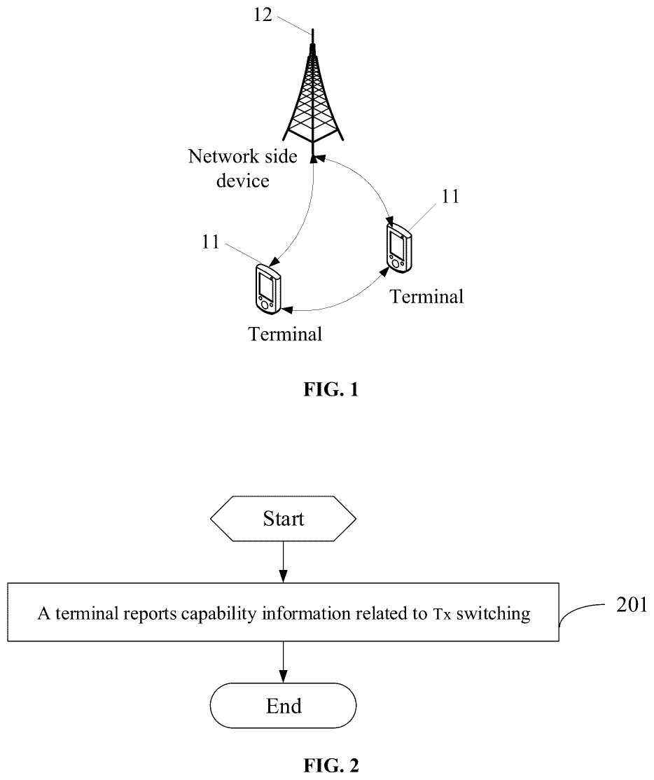

FIG. 1 is a block diagram of a wireless communication system to which the embodiments of this application can be applied. The wireless communication system includes a terminal 11 and a network side device 12. The terminal 11 may be a terminal side device such as a mobile phone, a tablet personal computer, a laptop computer or a notebook computer, a personal digital assistant (PDA), a palmtop computer, a netbook, an ultra-mobile personal computer (UMPC), a mobile internet device (MID), an augmented reality (AR)/virtual reality (VR) device, a robot, a wearable device, vehicle user equipment (VUE), pedestrian user equipment (PUE), a smart home (a home device with a wireless communication function, such as a refrigerator, a television, a washing machine, or a furniture), a game console, a personal computer (PC), a teller machine, or a self-service machine. The wearable device includes a smart watch, a smart band, a smart headset, smart glasses, smart jewelry (a smart bangle, a smart bracelet, a smart ring, a smart necklace, a smart anklet, and a smart chain), a smart wrist strap, a smart dress, and the like. It should be noted that a specific type of the terminal 11 is not limited in the embodiments of this application. The network side device 12 may include an access network device or a core network device. The access network device 12 may also be referred to as a radio access network device, a radio access network (RAN), a radio access network function, or a radio access network unit. The access network device 12 may include a base station, a wireless local area network (WLAN) access point, a Wi-Fi node, or the like. The base station may be referred to as a NodeB, an evolved NodeB (eNB), an access point, a base transceiver station (BTS), a radio base station, a radio transceiver, a basic service set (BSS), an extended service set (ESS), a home NodeB, a home evolved NodeB, a transmitting receiving point (TRP), or another appropriate term in the field. As long as a same technical effect is achieved, the base station is not limited to a specified technical term. It should be noted that, in this application, only a base station in an NR system is used as an example, and a specific type of the base station is not limited. The core network device may include but is not limited to at least one of the following: a core network node, a core network function, a mobility management entity (MME), an access and mobility management function (AMF), a session management function (SMF), a user plane function (UPF), a policy control function (PCF), a policy and charging rule function unit (PCRF), an edge application server discovery function (EASDF), unified data management (UDM), a unified data repository (UDR), a home subscriber server (HSS), a centralized network configuration (CNC), a network repository function (NRF), a network exposure function (NEF), a local NEF (L-NEF), a binding support function (BSF), an application function (AF), and the like. It should be noted that, in the embodiments of this application, only a core network device in an NR system is used as an example for description, and a specific type of the core network device is not limited.

With reference to the accompanying drawings, the following describes in detail a capability information reporting method, a capability information receiving method, a terminal, a device, and a storage medium provided in the embodiments of this application by using some embodiments and application scenarios thereof.

Referring to FIG. 2, FIG. 2 is a flowchart of a capability information reporting method according to an embodiment of this application. As shown in FIG. 2, the method includes the following steps:

Step 201: A terminal reports capability information related to Tx switching, where the capability information includes at least one of the following:
a capability of supporting parallel Tx switching;
a capability of supporting serial Tx switching; and
a maximum number of times of switching within a preset period.

In this embodiment of this application, the Tx switching may be uplink Tx switching (UL Tx switching), or may be SL Tx switching (SL TX switching). The Tx switching may also be referred to as transmitter switching.

That a terminal reports capability information related to Tx switching may be: the terminal reports, to a network side device, the capability information related to Tx switching, or reports, to a sidelink (SL) device, the capability information related to Tx switching.

The capability of supporting parallel Tx switching may be: whether at least one frequency domain resource group supports parallel Tx switching, for example, one band pair/band combination supports parallel Tx switching.

The capability of supporting serial Tx switching may be: whether at least one frequency domain resource group supports serial Tx switching, for example, one band pair/band combination supports serial Tx switching.

It should be noted that in this embodiment of this application, supporting may also be understood as associating or corresponding.

The maximum number of times of switching within the preset period may be a maximum number of times that the terminal can perform Tx switching within the preset period. The preset period may be reported by the terminal. For example, the capability information includes the preset period. Alternatively, the preset period is configured by the network side device, or is defined in a protocol.

In this embodiment of this application, the capability information is reported, so that Tx switching of the terminal can be prevented from being affected, thereby improving transmission performance of the terminal. For example, the network side device or the SL device determines, through the capability information, a related capability of supporting Tx switching by the terminal, so that the terminal can perform Tx switching in a communication transmission process, thereby improving transmission performance of the terminal.

In an optional implementation, the capability information further includes at least one of the following:
a frequency domain resource combination supporting Tx switching (Tx switching);
a switching period of Tx switching; and
a type of supported Tx switching.

That a terminal reports capability information related to Tx switching may be: the terminal reports, to a network side device, the capability information related to Tx switching, or reports, to a sidelink (SL) device, the capability information related to Tx switching.

In this embodiment of this application, the frequency domain resource combination may be a frequency domain resource pair or another type of frequency domain resource combination, for example, a frequency domain resource list (for example, a band list) or a frequency domain resource sequence (for example, a band sequence).

In this embodiment of this application, the frequency domain resource may include one of the following:
a band, a carrier, a bandwidth part (BWP), and a resource pool.

In an example in which the frequency domain resource is a band, the frequency domain resource combination supporting Tx switching may include: a band combination (for example, a band pair/band combination) supporting Tx switching.

The frequency domain resource combination supporting Tx switching may be: the frequency domain resource combination supports Tx switching within a group, for example, Tx switching within a band.

The switching period of Tx switching may be a period required for performing Tx switching within a frequency domain resource group, for example, a period required for performing Tx switching between one band pair/band combination.

The type of supported Tx switching may be a type of Tx switching supported within a frequency domain resource group, for example, a type of Tx switching supported between one band pair/band combination. In addition, the type herein may include whether transmission may be simultaneously performed between different bands.

In this implementation, at least one of the frequency domain resource combination supporting Tx switching (Tx switching), the switching period of Tx switching, and the type of supported Tx switching is further reported, so that the network side device or the SL device can determine more comprehensive capability information of the terminal through the foregoing capability information. In this way, the terminal can perform more flexible Tx switching in a communication transmission process, thereby improving transmission performance of the terminal.

In an optional implementation, the frequency domain resource combination supporting Tx switching is a frequency domain resource pair, and in a case that the terminal triggers Tx switching within a frequency domain resource pair in N frequency domain resource pairs, a period for which the terminal completes Tx switching in the N frequency domain resource pairs includes one of the following:
a minimum period in N switching periods;
a maximum period in the N switching periods;
a weighted sum of the N switching periods; and
a total period of the N switching periods, where
the N switching periods are switching periods respectively corresponding to the N frequency domain resource pairs, and N is an integer greater than 1.

That the terminal triggers Tx switching within a frequency domain resource pair in N frequency domain resource pairs may include:
the terminal simultaneously triggers Tx switching within the frequency domain resource pair in the N frequency domain resource pairs; or
the terminal triggers Tx switching within the frequency domain resource pair in the N frequency domain resource pairs within a preset period range; or
Tx switching triggered by the terminal within the frequency domain resource pair in the N frequency domain resource pairs meets a preset requirement, for example, a transmission interval before and after switching is less than or equal to a preset threshold.

The Tx switching within the frequency domain resource pair is Tx switching performed within the frequency domain resource pair, for example, switching between two frequency domain resources.

In this implementation, the terminal may perform Tx switching within the frequency domain resource pair in the N frequency domain resource pairs, so as to improve Tx switching performance of the terminal.

In this implementation, N may be an integer greater than or equal to 2.

In this implementation, the frequency domain resource combination supporting Tx switching included in the capability information may include the N frequency domain resource pairs; and the switching period required for Tx switching included in the capability information may include the N switching periods corresponding to the N frequency domain resource pairs.

Optionally, in a case that transmission performed by the terminal after Tx switching is transmission on one antenna port, the period for which the terminal completes Tx switching in the N frequency domain resource pairs includes the minimum period in the N switching periods.

The transmission performed by the terminal after Tx switching is transmission to be performed by the terminal, for example, data transmission to be performed by the terminal.

Optionally, in a case that the terminal supports parallel Tx switching between different frequency domain resources, the period for which the terminal completes Tx switching in the N frequency domain resource pairs includes the minimum period in the N switching periods.

In this case, the terminal supports parallel Tx switching between different frequency domain resources, thereby improving Tx switching efficiency of the terminal.

Optionally, in a case that transmission performed by the terminal after Tx switching includes at least one of transmission on a plurality of antenna ports and transmission on a plurality of frequency domain resources, the period for which the terminal completes Tx switching in the N frequency domain resource pairs includes the maximum period in the N switching periods.

In this case, because at least one of transmission on a plurality of antenna ports and transmission on a plurality of frequency domain resources is included, transmission performance of the terminal can be improved.

Optionally, in a case that the terminal supports parallel Tx switching between different frequency domain resources, the period for which the terminal completes Tx switching in the N frequency domain resource pairs includes the maximum period in the N switching periods.

In this case, parallel Tx switching between different frequency domain resources can be implemented, so as to complete Tx switching of N frequency domain resource pairs within the maximum period in the N switching periods. In this way, Tx switching efficiency of the terminal can also be improved.

Optionally, in a case that transmission performed by the terminal after Tx switching is at least one of transmission on a plurality of antenna ports and transmission on a plurality of frequency domain resources, the period for which the terminal completes Tx switching in the N frequency domain resource pairs includes the total period of the N switching periods.

In this case, because at least one of transmission on a plurality of antenna ports and transmission on a plurality of frequency domain resources is included, transmission performance of the terminal can be improved.

Optionally, in a case that the terminal supports serial Tx switching between different frequency domain resources, the period for which the terminal completes Tx switching in the N frequency domain resource pairs includes the total period of the N switching periods.

In this case, serial Tx switching between different frequency domain resources can be implemented.

The following uses an example in which a frequency domain resource pair is a band pair for description.

When a reporting capability parameter of the terminal includes a band pair supporting Tx switching and a corresponding Tx switching period Tm, it indicates that Tx switching may be performed between the band pair, and a period for switching a Tx between the band pair is Tm. When Tx switching is simultaneously triggered on N band pairs or Tx switching is triggered within a preset period range or a preset requirement is met when Tx switching is triggered (for example, a gap of uplink transmission before and after switching is less than or equal to a specified value). It is assumed that switching periods corresponding to the N band pairs are T1, T2, . . . , TN, a period for completing Tx switching in the N band pairs is any one of the following:
(a) Min (T1, T2, . . . , TN). Optionally, transmission after switching (for example, data transmission after switching) is transmission on one antenna port. Optionally, the terminal supports Tx parallel switching between different bands/carriers/BWPs/pools.
(b) Max (T1, T2, . . . , TN). Optionally, transmission after switching (for example, data transmission after switching) is transmission on a plurality of antenna ports or transmission on a plurality of bands/carriers/BWPs/pools. Optionally, the terminal supports Tx parallel switching between different bands/carriers/BWPs/pools.
(c) Weighted sum of at least two of T1, T2, . . . , TN.
(d) The switching period may be sum (T1, T2, . . . , TN). Optionally, the terminal supports Tx serial switching between different bands/carriers/BWPs/pools. Optionally, data transmission after switching is transmission on a plurality of antenna ports or transmission on a plurality of bands/carriers/BWPs/pools.

For example, a switching period is configured based on a band pair. The capability information reported by the terminal includes switching periods of Tx switching between three bands, where a switching period of a band A and a band B is T1, and a switching period of the band A and a band C is T2.

Each band has only one carrier. When uplink transmission on two antenna ports is performed on a carrier 1 of the band A, and DCI is scheduled on a carrier 2 and a carrier 3 of the band B and the band C to perform uplink carrier aggregation transmission, Tx is switched from the band A to the band B and the band C, and a switching period is T3=max (T1, T2). Optionally, the terminal cannot perform transmission on the carrier 1/2/3 within the period T3.

For another example, a switching period is configured based on a band combination. It indicates that all bands in the band combination may be switched, and a switching period is related to a number of band s on which a transmission state changes before and after switching. For example, a switching period of switching from a band A to a band B is T1, a switching period of switching from the band A to a band C is T2, and a switching period of switching from the band A to the band B and the band C is T3=max (T1 and T2).

Configuration signaling may include a plurality of switching periods and a number of allowed bands in a band combination. Specific content may be as follows:

```
  BandCombination-UplinkTxSwitch-r16 ::= SEQUENCE {
    BandCombination BandCombination,
    UplinkTxSwitchingPeriodlist SEQUENCE (SIZE
(1..maxULTxSwitchinguplinkTxSwitchingPeriodlist)) OF uplinkTxSwitchingPeriod,
  UplinkTxSwitchingPeriod ::= SEQUENCE {
    Period
  INTEGER (n35 us, n160 us, n210 us)
Numberofband
  INTEGER (0..32),
    ...
  }}
```

As described in the foregoing signaling content, switching periods may include n35 us, n160 us, and n210 us, and numbers of allowed bands in a band combination are 0 to 32. In this way, a specific switching period may be configured based on a switching period and a number of bands on which a transmission state changes before and after switching in actual configuration.

When the terminal is configured with three bands, a band A, a band B, and a band C belong to an uplink Tx switching combination (ULTxswitchingBandCombination), and therefore switching is supported between the band A/B/C. A switching period of two bands is T1, and a switching period of three bands is T2.

Each band has only one carrier. When uplink transmission on two antenna ports is performed on a carrier 1 of the band A and DCI is scheduled on a carrier 2 and a carrier 3 of the band B and the band C to perform uplink carrier aggregation transmission, Tx is switched from the band A to the band B and the band C. Optionally, the terminal cannot perform transmission on the carrier 1/2/3 within the period T2.

In an optional implementation, in the frequency domain resource combination supporting Tx switching, Tx switching is supported between at least two frequency domain resources.

That Tx switching is supported between at least two frequency domain resources may be: Tx switching is supported between any two or more frequency domain resources, or switching between frequency domain resource pairs, that is, switching between a plurality of frequency domain resources and a plurality of other frequency domain resources.

In an example in which the frequency domain resource is a band, the capability information reported by the terminal may include a band combination supporting Tx switching. For example, the capability information includes indexes of N1 bands, indicating that Tx switching may be performed between at least two pairs of bands or any two bands in each band combination, where N1 is an integer greater than or equal to 1.

In this implementation, Tx switching is supported between at least two frequency domain resources, and Tx switching is supported between any two frequency domain resources, thereby improving Tx switching flexibility of the terminal.

In an optional implementation, the switching period of Tx switching includes:
a switching period of M frequency domain resources in one or more frequency domain resource combinations supporting Tx switching, where M is a positive integer; and
the M frequency domain resources include one of the following:
a frequency domain resource on which transmission or scheduling by the terminal occurs before and/or after Tx switching;
a frequency domain resource on which transmission or scheduling by the terminal changes before and after Tx switching;
all frequency domain resources in the frequency domain resource combination supporting Tx switching;
a frequency domain resource configured through carrier aggregation in the frequency domain resource combination supporting Tx switching; and
a frequency domain resource activated through carrier aggregation in the frequency domain resource combination supporting Tx switching.

The frequency domain resource on which transmission or scheduling changes may mean a change in a number of ports, and another transmission parameter may change or remain unchanged.

In this implementation, because the switching period of the M frequency domain resources is included, it can be avoided that both transmission parties have inconsistent understanding of the switching period of the M frequency domain resources, thereby improving transmission performance of the terminal.

In an example in which the frequency domain resource is a band, the capability information of the terminal includes a Tx switching period corresponding to M (M≤N1) bands in a band combination, where
the M bands may be understood as all bands on which transmission by the terminal occurs before and/or after Tx switching;
the M bands may be understood as all bands on which a transmission state of the terminal changes before and after Tx switching;
the M bands are understood as all bands in the band combination; or
the M bands are understood as all bands configured/activated through carrier aggregation.

In an optional implementation, the capability of supporting parallel Tx switching includes at least one of the following:
allowing switching periods of different Tx switching to at least partially overlap;
allowing an interval between switching periods of different Tx switching to be less than or equal to a first preset threshold;
allowing another Tx to switch or to be triggered switching after Tx switching is triggered;
allowing another Tx to switch or to be triggered switching before switched transmission starts or ends; and
allowing another Tx to switch or to be triggered switching after switched transmission starts.

The allowing another Tx to switch or to be triggered switching after Tx switching is triggered may include:
allowing another Tx to switch or to be triggered switching within a first predetermined period after Tx switching is triggered.

The allowing another Tx to switch or to be triggered switching before switched transmission starts or ends may include:
allowing another Tx to switch or to be triggered switching within a second predetermined period before switched transmission starts or ends.

The allowing another Tx to switch or to be triggered switching after switched transmission starts may include:
allowing another Tx to switch or to be triggered switching within a third predetermined period after switched transmission starts.

The first predetermined period, the second predetermined period, and the third predetermined period may be reported by the terminal. For example, the capability information further includes at least one of the following: the first predetermined period, the second predetermined period, and the third predetermined period. Alternatively, the first predetermined period, the second predetermined period, and the third predetermined period may be defined in a protocol or configured on a network side.

It should be noted that, in some implementations, the first predetermined period, the second predetermined period, and the third predetermined period may not be configured, or the first predetermined period, the second predetermined period, and the third predetermined period are 0.

In this implementation, a plurality of types of parallel switching can be supported, thereby improving Tx switching performance of the terminal.

In an optional implementation, the capability of supporting serial Tx switching includes at least one of the following:
switching periods of different Tx switching do not overlap;
allowing an interval between switching periods of different Tx switching to be greater than or equal to a second preset threshold;
disallowing another Tx to switch or to be triggered switching after Tx switching is triggered;
disallowing another Tx to switch or to be triggered switching before switched transmission starts or ends; and
disallowing another Tx to switch or to be triggered switching after switched transmission starts.

The disallowing another Tx to switch or to be triggered switching after Tx switching is triggered may include:
disallowing another Tx to switch or to be triggered switching within a fourth predetermined period after Tx switching is triggered.

The disallowing another Tx to switch or to be triggered switching before switched transmission starts or ends may include:
disallowing another Tx to switch or to be triggered switching within a fifth predetermined period before switched transmission starts or ends.

The disallowing another Tx to switch or to be triggered switching after switched transmission starts may include:
disallowing another Tx to switch or to be triggered switching within a sixth predetermined period after switched transmission starts.

The fourth predetermined period, the fifth predetermined period, and the sixth predetermined period may be reported by the terminal. For example, the capability information further includes at least one of the following: the fourth predetermined period, the fifth predetermined period, and the sixth predetermined period. Alternatively, the fourth predetermined period, the fifth predetermined period, and the sixth predetermined period may be defined in a protocol or configured on a network side.

It should be noted that, in some implementations, the fourth predetermined period, the fifth predetermined period, and the sixth predetermined period may not be configured, or the fourth predetermined period, the fifth predetermined period, and the sixth predetermined period are 0.

In this implementation, a plurality of types of serial switching can be supported, thereby improving Tx switching performance of the terminal.

In an optional implementation, in a case that Tx switching is triggered on X frequency domain resources,
the terminal cannot perform transmission or cannot be scheduled on a first target frequency domain resource within a switching period of the X frequency domain resources, and the first target frequency domain resource includes the X frequency domain resources or the first target frequency domain resource includes at least one of the following:
a frequency domain resource corresponding to transmission before switching;
a frequency domain resource corresponding to switched transmission;
a frequency domain resource on which transmission changes before switching; and
a frequency domain resource on which transmission changes after switching; and/or
in a case that Tx switching is triggered on X frequency domain resources,
the terminal cannot perform transmission or cannot be scheduled on a second target frequency domain resource within a switching period of the m^{th} frequency domain resource pair in the X frequency domain resources, and the second target frequency domain resource includes the m^{th} frequency domain resource pair or the second target frequency domain resource includes at least one of the following in the m^{th} frequency domain resource pair:
a frequency domain resource on which transmission changes before switching; and
a frequency domain resource on which transmission changes after switching, where
X and m are positive integers.

The m^{th} frequency domain resource pair may be a specific, preset, or random frequency domain resource pair.

That Tx switching is triggered on the X frequency domain resources may include at least one of the following:
Tx switching is simultaneously triggered on the X frequency domain resources;
Tx switching is triggered within a preset period range on the X frequency domain resources; and
a preset condition is met when Tx switching is triggered on the X frequency domain resources.

The preset condition may be that an interval of uplink transmission or SL sending before and/or after switching is less than or equal to a preset threshold.

In this implementation, because the terminal cannot perform transmission or cannot be scheduled on the first target frequency domain resource within the switching period of the X frequency domain resources, and the terminal cannot perform transmission or cannot be scheduled on the second target frequency domain resource within the switching period of the m^{th} frequency domain resource pair in the X frequency domain resources, transmission reliability of terminal can be improved.

In an example in which the foregoing frequency domain resource is a band:
When Tx switching is simultaneously triggered on X bands, Tx switching is triggered within a preset period range, or a preset requirement 1 is met when Tx switching is triggered (for example, a gap of uplink transmission or SL sending before and/or after switching is less than or equal to a specified value), the terminal cannot perform transmission/cannot be scheduled on the X bands within a Tx switching period, or the terminal performs transmission/is scheduled on carriers/BWPs/pools of all bands for transmission before and/or after Tx switching (for example, at least some carriers/BWPs/pools or any carrier/BWP/pool);
when Tx switching is simultaneously triggered on X bands, Tx switching is triggered within a preset period range, or a preset requirement 2 is met when Tx switching is triggered (for example, a gap of uplink transmission or SL sending before and/or after switching is less than or equal to a specified value), the terminal cannot perform transmission/cannot be scheduled on the X bands within a Tx switching period, or the terminal performs transmission/is scheduled on carriers/BWPs/pools of bands on which a transmission state changes before and/or after Tx switching (for example, at least some carriers/BWPs/pools or any carrier/BWP/pool); or
when Tx switching is simultaneously triggered on X bands, Tx switching is triggered within a preset period range, or a preset requirement 3 is met when Tx switching is triggered (for example, a gap of uplink transmission or SL sending before and/or after switching is less than or equal to a specified value), the terminal cannot perform transmission/cannot be scheduled on a carrier/BWP/pool on the m^{th} band pair within a Tx switching period Tm (for example, at least some carriers/BWPs/pools or any carrier/BWP/pool), or the terminal cannot perform transmission/cannot be scheduled on a carrier/BWP/pool of a band on which a transmission state changes before and/or after Tx switching on the m^{th} band pair within a Tx switching period Tm (for example, at least some carriers/BWPs/pools or any carrier/BWP/pool).

In an optional implementation, after O times of switching, switching is allowed only after at least a seventh predetermined period elapses; or
after O times of switching, no further switching is expected within an eighth predetermined period, where
O is a positive integer.

In some implementations, a value of O is related to a capability of the terminal, that is, a specified number of times is related to the capability of the terminal.

The seventh predetermined period and the eighth predetermined period may be one or more slots, and may be specifically determined by the terminal by reporting, or may be configured by the network side device, or may be defined in a protocol.

In this implementation, after O times of switching, switching is allowed only after at least the seventh predetermined period elapses, or no further switching is expected within the eighth predetermined period, so that frequent switching of the terminal can be avoided.

For example, in a predefined period (for example, one or more slots), a number of times of Tx switching cannot exceed the specified number of times.

Alternatively, after one time of switching or O times of switching, switching can be performed only after at least a predefined period (for example, one or more slots) elapses; or after one time of switching or O times of switching, no further switching is expected within at least a predefined period (for example, one or more slots).

Optionally, the seventh predetermined period or the eighth predetermined period is one slot, and a subcarrier spacing (SCS) corresponding to the one slot is a maximum or minimum SCS in a switching process, where the maximum or minimum SCS includes one of the following:
a maximum or minimum SCS in SCSs of carriers or bandwidth parts BWPs that participate in switching;
a maximum or minimum SCS of a band that participates in switching;
a maximum or minimum SCS in SCSs corresponding to frequency domain resources or of N bands corresponding to switching, where N is an integer greater than 1; and
a maximum or minimum SCS in SCSs of all bands, carriers, or BWPs that are configured for the terminal.

For example, an SCS corresponding to one slot is a maximum or minimum SCS in SCSs in a switching process. The minimum or maximum SCS may be any one of the following:
a minimum or maximum SCS in SCSs of carriers or BWPs that participate in switching;
a minimum or maximum SCS of a band (a carrier or a BWP) that participates in switching;
a minimum or maximum SCS in SCSs of corresponding band pairs or N bands (carriers or BWPs); and
a minimum or maximum SCS in SCSs of all bands, or all carriers, or all BWPs that are configured for the UE.

In this embodiment of this application, the BWP may be an UL BWP or an SL BWP.

In an optional implementation, switching that meets at least one of the following is one time of switching:
time points at which Tx switching is triggered are the same;
downlink control information (DCI) triggered by Tx switching is the same;
target frequency domain resources after switching are the same;
source frequency domain resources before switching are the same; and
start time points of target uplink transmission after switching are the same or within a ninth predetermined period.

The target frequency domain resource after switching may be a frequency domain resource used for transmission after switching, and the source frequency domain resource before switching may be a frequency domain resource used for transmission before switching.

In this implementation, one or more times of switching with a same Tx switching trigger time/same DCI may be defined as one time of switching; one or more times of switching with a same target frequency domain resource after switching is defined as one time of switching; one or more times of switching with a same source frequency domain resource before switching is defined as one time of switching; and one or more times of switching with a same start time of uplink transmission or SL transmission or within a predefined period after switching may be defined as one time of switching.

In an optional implementation, the switching period of Tx switching is associated with at least one of the following:
a number of antenna ports for transmission and an index of an antenna port for transmission.

A relationship between the number of antenna ports for transmission and the index of the antenna port for transmission, and the switching period may be preconfigured, for example, defined in a protocol, or configured by the network side device.

In an optional implementation, an event that meets at least one of the following is Tx switching:
an index of a frequency domain resource for transmission changes;
a number of Txs, antenna ports, layers, or resource pools for transmission changes; and
a number of frequency domain resources for transmission changes.

In this implementation, only one of the above is also Tx switching. For example, that a resource index changes, or only a number of Txs, antenna ports, layers, or resource pools changes, or only a number of frequency domain resources changes is Tx switching.

In this embodiment of this application, a terminal reports capability information related to Tx switching, where the capability information includes at least one of the following: a capability of supporting parallel Tx switching; a capability of supporting serial Tx switching; and a maximum number of times of switching within a preset period. In this way, the capability information related to Tx switching of the terminal is reported, so that Tx switching of the terminal can be prevented from being affected, thereby improving transmission performance of the terminal.

In addition, in this embodiment of this application, UL Tx switching on more than two bands may be implemented, a period in a Tx switching process and corresponding terminal behavior may be determined, and switching terminal capability parameter reporting and the corresponding terminal behavior during UL Tx switching on more than two bands are defined.

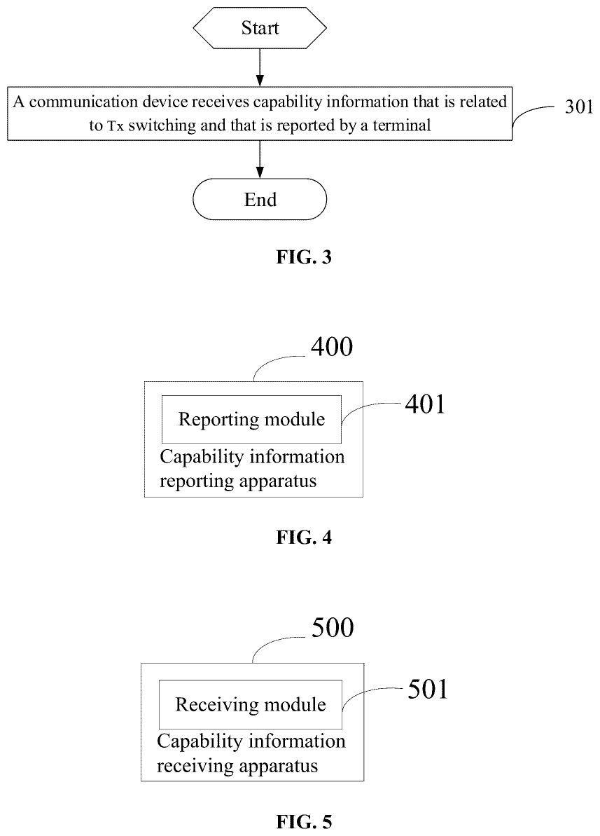

Referring to FIG. 3, FIG. 3 is a flowchart of a capability information receiving method according to an embodiment of this application. As shown in FIG. 3, the method includes the following steps.

Step 301: A communication device receives capability information that is related to Tx switching and that is reported by a terminal, where the capability information includes at least one of the following:
a capability of supporting parallel Tx switching;
a capability of supporting serial Tx switching; and
a maximum number of times of switching within a preset period.

The communication device may be a network side device or an SL device.

Optionally, the capability information further includes at least one of the following:
a frequency domain resource combination supporting Tx switching;
a switching period of Tx switching; and
a type of supported Tx switching.

Optionally, the frequency domain resource combination supporting Tx switching is a frequency domain resource pair, and in a case that the terminal triggers Tx switching within a frequency domain resource pair in N frequency domain resource pairs, a period for which the terminal completes Tx switching in the N frequency domain resource pairs includes one of the following:
a minimum period in N switching periods;
a maximum period in the N switching periods;
a weighted sum of the N switching periods; and
a total period of the N switching periods, where
the N switching periods are switching periods respectively corresponding to the N frequency domain resource pairs, and N is an integer greater than 1.

Optionally, in a case that transmission performed by the terminal after Tx switching is transmission on one antenna port, the period for which the terminal completes Tx switching in the N frequency domain resource pairs includes the minimum period in the N switching periods; and/or
in a case that the terminal supports parallel Tx switching between different frequency domain resources, the period for which the terminal completes Tx switching in the N frequency domain resource pairs includes the minimum period in the N switching periods.

Optionally, in a case that transmission performed by the terminal after Tx switching includes at least one of transmission on a plurality of antenna ports and transmission on a plurality of frequency domain resources, the period for which the terminal completes Tx switching in the N frequency domain resource pairs includes the maximum period in the N switching periods; and/or
in a case that the terminal supports parallel Tx switching between different frequency domain resources, the period for which the terminal completes Tx switching in the N frequency domain resource pairs includes the maximum period in the N switching periods.

Optionally, in a case that transmission performed by the terminal after Tx switching is at least one of transmission on a plurality of antenna ports and transmission on a plurality of frequency domain resources, the period for which the terminal completes Tx switching in the N frequency domain resource pairs includes the total period of the N switching periods; and/or
in a case that the terminal supports serial Tx switching between different frequency domain resources, the period for which the terminal completes Tx switching in the N frequency domain resource pairs includes the total period of the N switching periods.

Optionally, in the frequency domain resource combination supporting Tx switching, Tx switching is supported between at least two frequency domain resources.

Optionally, the switching period of Tx switching includes:
a switching period of M frequency domain resources in one or more frequency domain resource combinations supporting Tx switching, where M is a positive integer; and
the M frequency domain resources include one of the following:
a frequency domain resource on which transmission or scheduling by the terminal occurs before and/or after Tx switching;
a frequency domain resource on which transmission or scheduling by the terminal changes before and after Tx switching;
all frequency domain resources in the frequency domain resource combination supporting Tx switching;
a frequency domain resource configured through carrier aggregation in the frequency domain resource combination supporting Tx switching; and
a frequency domain resource activated through carrier aggregation in the frequency domain resource combination supporting Tx switching.

Optionally, the capability of supporting parallel Tx switching includes at least one of the following:
allowing switching periods of different Tx switching to at least partially overlap;
allowing an interval between switching periods of different Tx switching to be less than or equal to a first preset threshold;
allowing another Tx to switch or to be triggered switching after Tx switching is triggered;
allowing another Tx to switch or to be triggered switching before switched transmission starts or ends; and
allowing another Tx to switch or to be triggered switching after switched transmission starts.

Optionally, the allowing another Tx to switch or to be triggered switching after Tx switching is triggered includes:
allowing another Tx to switch or to be triggered switching within a first predetermined period after Tx switching is triggered; and/or
the allowing another Tx to switch or to be triggered switching before switched transmission starts or ends includes:
allowing another Tx to switch or to be triggered switching within a second predetermined period before switched transmission starts or ends; and/or
the allowing another Tx to switch or to be triggered switching after switched transmission starts includes:
allowing another Tx to switch or to be triggered switching within a third predetermined period after switched transmission starts.

Optionally, the capability information further includes at least one of the following:
the first predetermined period, the second predetermined period, and the third predetermined period.

Optionally, the capability of supporting serial Tx switching includes at least one of the following:
switching periods of different Tx switching do not overlap;
allowing an interval between switching periods of different Tx switching to be greater than or equal to a second preset threshold;
disallowing another Tx to trigger switching after Tx switching is triggered;
disallowing another Tx to trigger switching before switched transmission starts or ends; and
disallowing another Tx to trigger switching after switched transmission starts.

Optionally, the disallowing another Tx to trigger switching after Tx switching is triggered includes:
disallowing another Tx to trigger switching within a fourth predetermined period after Tx switching is triggered; and/or
the disallowing another Tx to trigger switching before switched transmission starts or ends includes:
disallowing another Tx to trigger switching within a fifth predetermined period before switched transmission starts or ends; and/or
the disallowing another Tx to trigger switching after switched transmission starts includes:
disallowing another Tx to trigger switching within a sixth predetermined period after switched transmission starts.

Optionally, the capability information further includes at least one of the following:
the fourth predetermined period, the fifth predetermined period, and the sixth predetermined period.

Optionally, in a case that Tx switching is triggered on X frequency domain resources,
the terminal cannot perform transmission or cannot be scheduled on a first target frequency domain resource within a switching period of the X frequency domain resources, and the first target frequency domain resource includes the X frequency domain resources or the first target frequency domain resource includes at least one of the following:
a frequency domain resource corresponding to transmission before switching;
a frequency domain resource corresponding to switched transmission;
a frequency domain resource on which transmission changes before switching; and
a frequency domain resource on which transmission changes after switching; and/or
in a case that Tx switching is triggered on X frequency domain resources,
the terminal cannot perform transmission or cannot be scheduled on a second target frequency domain resource within a switching period of the m^{th} frequency domain resource pair in the X frequency domain resources, and the second target frequency domain resource includes the m^{th} frequency domain resource pair or the second target frequency domain resource includes at least one of the following in the m^{th} frequency domain resource pair:
a frequency domain resource on which transmission changes before switching; and
a frequency domain resource on which transmission changes after switching, where
X and m are positive integers.

Optionally, that Tx switching is triggered on the X frequency domain resources includes at least one of the following:
Tx switching is simultaneously triggered on the X frequency domain resources;
Tx switching is triggered within a preset period range on the X frequency domain resources; and
a preset condition is met when Tx switching is triggered on the X frequency domain resources.

Optionally, after O times of switching, switching is allowed only after at least a seventh predetermined period elapses; or
after O times of switching, no further switching is expected within an eighth predetermined period, where
O is a positive integer.

Optionally, the seventh predetermined period or the eighth predetermined period is one slot, and a subcarrier spacing SCS corresponding to the one slot is a maximum or minimum SCS in a switching process, where the maximum or minimum SCS includes one of the following:
a maximum or minimum SCS in SCSs of carriers or bandwidth parts BWPs that participate in switching;
a maximum or minimum SCS of a band that participates in switching;
a maximum or minimum SCS in SCSs corresponding to frequency domain resources or of N bands corresponding to switching, where N is an integer greater than 1; and
a maximum or minimum SCS in SCSs of all bands, carriers, or BWPs that are configured for the terminal.

Optionally, switching that meets at least one of the following is one time of switching:
time points at which Tx switching is triggered are the same;
downlink control information DCI triggered by Tx switching is the same;
target frequency domain resources after switching are the same;
source frequency domain resources before switching are the same; and
start time points of target uplink transmission after switching are the same or within a ninth predetermined period.

Optionally, an event that meets at least one of the following is Tx switching:
an index of a frequency domain resource for transmission changes;
a number of Txs, antenna ports, layers, or resource pools for transmission changes; and
a number of frequency domain resources for transmission changes.

Optionally, the switching period of Tx switching is associated with at least one of the following:
a number of antenna ports for transmission and an index of an antenna port for transmission.

Optionally, the frequency domain resource includes one of the following:
a band, a carrier, a BWP, and a resource pool.

It should be noted that this embodiment is used as an implementation of the communication device corresponding to the embodiment shown in FIG. 2. For a specific implementation, refer to the related descriptions of the embodiment shown in FIG. 2. To avoid repeated description, details are not described again in this embodiment.

The following uses an example in which a frequency domain resource is a band to describe Tx switching in the embodiments of this application.

In the following embodiment, there may be a mode 1 and a mode 2 based on whether a plurality of frequency domain resources support simultaneous uplink transmission. In mode 1, uplink transmission cannot be simultaneously performed on a plurality of carriers, and in mode 2, uplink transmission may be simultaneously performed on a plurality of carriers. In addition, N indicates that N bands are configured for the terminal, and M indicates that the terminal has M Txs, or the terminal can simultaneously perform transmission on a maximum of M Txs.

### Embodiment 1-0

In this implementation, when N=3, M=2, and three carriers are respectively on three bands, the terminal may have at least one of the following combination of Tx and/or antenna ports shown in Table 1, where mode 1 and mode 2 are configured or indicated by a network. A number of Tx and a number of ports of a carrier 1, a carrier 2, and a carrier 3 may be shown in Table 1.

TABLE 1

| | | Number of antenna ports for uplink |
|---|---|---|
| | | transmission (band A (carrier 1) + band B |
| | Number of Txs | (carrier 2) + band C (carrier 3)) |
| Case 1 | 1T + 1T + 0T | 1P + 0P + 0P, 0P + 1P + 0P |
| Case 2 | 0T + 2T + 0T | 0P + 2P + 0P, 0P + 1P + 0P |
| Case 3 | 2T + 0T + 0T | 2P + 0P + 0P, 1P + 0P + 0P |
| Case 4 | 0T + 0T + 2T | 0P + 0P + 2P, 0P + 0P + 1P |
| Case 5 | 1T + 0T + 1T | 1P + 0P + 0P, 0P + 0P + 1P |
| Case 6 | 0T + 1T + 1T | 0P + 1P + 0P, 0P + 0P + 1P |

All possible switching schemes may be shown in the following plurality of tables.

A first switching scheme shown in Table 2 is switching from a case 1 to a case 2, for example, switching from 1P+0P+0P to 0P+2P+0P or 0P+1P+0P, or may be switching from a case 2 to a case 1. In other words, different cases in the tables provided in this embodiment of this application may be switched to each other.

TABLE 2

| | | Number of antenna ports for uplink |
|---|---|---|
| | | transmission (band A (carrier 1) + band B |
| | Number of Txs | (carrier 2) + band C (carrier 3)) |
| Case 1 | 1T + 1T + 0T | 1P + 0P + 0P, 0P + 1P + 0P |
| Case 2 | 0T + 2T + 0T | 0P + 2P + 0P, 0P + 1P + 0P |

TABLE 3

| | | Number of antenna ports for uplink |
|---|---|---|
| | | transmission (band A (carrier 1) + band B |
| | Number of Txs | (carrier 2) + band C (carrier 3)) |
| Case 1 | 1T + 1T + 0T | 1P + 0P + 0P, 0P + 1P + 0P |
| Case 3 | 2T + 0T + 0T | 2P + 0P + 0P, 1P + 0P + 0P |

TABLE 4

| | | Number of antenna ports for uplink |
|---|---|---|
| | | transmission (band A (carrier 1) + band B |
| | Number of Txs | (carrier 2) + band C (carrier 3)) |
| Case 2 | 0T + 2T + 0T | 0P + 2P + 0P, 0P + 1P + 0P |
| Case 6 | 0T + 1T + 1T | 0P + 1P + 0P, 0P + 0P + 1P |

TABLE 5

| | | Number of antenna ports for uplink |
|---|---|---|
| | | transmission (band A (carrier 1) + band B |
| | Number of Txs | (carrier 2) + band C (carrier 3)) |
| Case 3 | 2T + 0T + 0T | 2P + 0P + 0P, 1P + 0P + 0P |
| Case 5 | 1T + 0T + 1T | 1P + 0P + 0P, 0P + 0P + 1P |

TABLE 6

| | | Number of antenna ports for uplink |
|---|---|---|
| | | transmission (band A (carrier 1) + band B |
| | Number of Txs | (carrier 2) + band C (carrier 3)) |
| Case 4 | 0T + 0T + 2T | 0P + 0P + 2P, 0P + 0P + 1P |
| Case 5 | 1T + 0T + 1T | 1P + 0P + 0P, 0P + 0P + 1P |

TABLE 7

| | | Number of antenna ports for uplink |
|---|---|---|
| | | transmission (band A (carrier 1) + band B |
| | Number of Txs | (carrier 2) + band C (carrier 3)) |
| Case 4 | 0T + 0T + 2T | 0P + 0P + 2P, 0P + 0P + 1P |
| Case 6 | 0T + 1T + 1T | 0P + 1P + 0P, 0P + 0P + 1P |

TABLE 8

| | | Number of antenna ports for uplink |
|---|---|---|
| | | transmission (band A (carrier 1) + band B |
| | Number of Txs | (carrier 2) + band C (carrier 3)) |
| Case 2 | 0T + 2T + 0T | 0P + 2P + 0P, 0P + 1P + 0P |
| Case 3 | 2T + 0T + 0T | 2P + 0P + 0P, 1P + 0P + 0P |

TABLE 9

| | | Number of antenna ports for uplink |
|---|---|---|
| | | transmission (band A (carrier 1) + band B |
| | Number of Txs | (carrier 2) + band C (carrier 3)) |
| Case 2 | 0T + 2T + 0T | 0P + 2P + 0P, 0P + 1P + 0P |
| Case 4 | 0T + 0T + 2T | 0P + 0P + 2P, 0P + 0P + 1P |

TABLE 10

| | | Number of antenna ports for uplink |
|---|---|---|
| | | transmission (band A (carrier 1) + band B |
| | Number of Txs | (carrier 2) + band C (carrier 3)) |
| Case 3 | 2T + 0T + 0T | 2P + 0P + 0P, 1P + 0P + 0P |
| Case 4 | 0T + 0T + 2T | 0P + 0P + 2P, 0P + 0P + 1P |

In the switching cases in Table 2 to Table 10, Tx switching is performed on only two bands, that is, there are a total of two bands for transmission before and after switching.

TABLE 11

| | | Number of antenna ports for uplink |
|---|---|---|
| | | transmission (band A (carrier 1) + band B |
| | Number of Txs | (carrier 2) + band C (carrier 3) |
| Case 1 | 1T + 1T + 0T | 1P + 0P + 0P, 0P + 1P + 0P |
| Case 5 | 1T + 0T + 1T | 1P + 0P + 0P, 0P + 0P + 1P |

TABLE 12

| | | Number of antenna ports for uplink |
|---|---|---|
| | | transmission (band A (carrier 1) + band B |
| | Number of Txs | (carrier 2) + band C (carrier 3)) |
| Case 1 | 1T + 1T + 0T | 1P + 0P + 0P, 0P + 1P + 0P |
| Case 6 | 0T + 1T + 1T | 0P + 1P + 0P, 0P + 0P + 1P |

TABLE 13

| | | Number of antenna ports for uplink |
|---|---|---|
| | | transmission (band A (carrier 1) + band B |
| | Number of Txs | (carrier 2) + band C (carrier 3)) |
| Case 5 | 1T + 0T + 1T | 1P + 0P + 0P, 0P + 0P + 1P |
| Case 6 | 0T + 1T + 1T | 0P + 1P + 0P, 0P + 0P + 1P |

TABLE 14

| | | Number of antenna ports for uplink |
|---|---|---|
| | | transmission (band A (carrier 1) + band B |
| | Number of Txs | (carrier 2) + band C (carrier 3)) |
| Case 1 | 1T + 1T + 0T | 1P + 0P + 0P, 0P + 1P + 0P |
| Case 4 | 0T + 0T + 2T | 0P + 0P + 2P, 0P + 0P + 1P |

TABLE 15

| | | Number of antenna ports for uplink |
|---|---|---|
| | | transmission (band A (carrier 1) + band B |
| | Number of Txs | (carrier 2) + band C (carrier 3)) |
| Case 2 | 0T + 2T + 0T | 0P + 2P + 0P, 0P + 1P + 0P |
| Case 5 | 1T + 0T + 1T | 1P + 0P + 0P, 0P + 0P + 1P |

TABLE 16

| | | Number of antenna ports for uplink |
|---|---|---|
| | | transmission (band A (carrier 1) + band B |
| | Number of Txs | (carrier 2) + band C (carrier 3)) |
| Case 3 | 2T + 0T + 0T | 2P + 0P + 0P, 1P + 0P + 0P |
| Case 6 | 0T + 1T + 1T | 0P + 1P + 0P, 0P + 0P + 1P |

In switching from Table 11 to Table 16, Tx switching is performed on three bands, that is, there are a total of three bands for transmission before and after switching.

When mode 1 is configured, and only transmission on one port can be supported, performed, configured, or scheduled on each band. When 1Tx-1Tx switching is performed on any two bands, the terminal cannot perform transmission on two carriers/any carrier for switching within a switching period.

A combination of each Tx corresponds to a combination of one antenna port. Therefore, transmission on one port is performed on one band before switching, and the UE performs transmission on one port on another band after switching. Details may be shown in Table 17.

TABLE 17

| | | Number of antenna ports for uplink |
|---|---|---|
| | | transmission (band A (carrier 1) + band B |
| | Number of Txs | (carrier 2) + band C (carrier 3)) |
| Case 1 | 1T + 1T + 0T | 1P + 0P + 0P |
| Case 5 | 1T + 0T + 1T | 0P + 0P + 1P |
| Case 6 | 0T + 1T + 1T | 0P + 1P + 0P |

Alternatively, a combination of each Tx corresponds to a combination of a plurality of antenna ports. Therefore, transmission on one port is performed on one band before switching, and the UE performs transmission on one port on another band after switching. Details may be shown in 18.

TABLE 18

| | | Number of antenna ports for uplink |
|---|---|---|
| | | transmission (band A (carrier 1) + band B |
| | Number of Txs | (carrier 2) + band C (carrier 3)) |
| Case 1 | 1T + 1T + 0T | 1P + 0P + 0P, 0P + 1P + 0P |
| Case 5 | 1T + 0T + 1T | 1P + 0P + 0P, 0P + 0P + 1P |
| Case 6 | 0T + 1T + 1T | 0P + 1P + 0P, 0P + 0P + 1P |

### Embodiment 1-2

When mode 1 is configured and one Tx on each of two bands is switched to a third band:
transmission on one port is performed on one band before switching, and the UE performs transmission on one port on another band after switching; or
transmission on one port is performed on one band before switching, and the UE performs transmission on two ports on another band after switching.

### Embodiment 1-3

When mode 1 is configured and two Txs on one band are switched to other two bands:
transmission on one port is performed on one band before switching, and the UE performs transmission on one port on another band after switching; or
transmission on two ports is performed on one band before switching, and the UE performs transmission on one port on another band after switching. Details may be shown in Table 19, Table 20, or Table 21.

TABLE 19

| | | Number of antenna ports for uplink |
|---|---|---|
| | | transmission (band A (carrier 1) + band B |
| | Number of Txs | (carrier 2) + band C (carrier 3)) |
| Case 1 | 1T + 1T + 0T | 1P + 0P + 0P, 0P + 1P + 0P |
| Case 4 | 0T + 0T + 2T | 0P + 0P + 2P, 0P + 0P + 1P |

TABLE 20

| | | Number of antenna ports for uplink |
|---|---|---|
| | | transmission (band A (carrier 1) + band B |
| | Number of Txs | (carrier 2) + band C (carrier 3)) |
| Case 2 | 0T + 2T + 0T | 0P + 2P + 0P, 0P + 1P + 0P |
| Case 5 | 1T + 0T + 1T | 1P + 0P + 0P, 0P + 0P + 1P |

TABLE 21

| | | Number of antenna ports for uplink |
|---|---|---|
| | | transmission (band A (carrier 1) + band B |
| | Number of Txs | (carrier 2) + band C (carrier 3)) |
| Case 3 | 2T + 0T + 0T | 2P + 0P + 0P, 1P + 0P + 0P |
| Case 6 | 0T + 1T + 1T | 0P + 1P + 0P, 0P + 0P + 1P |

When mode 2 is configured, combinations shown in Table 22 may exist when data may be simultaneously sent on different bands/carriers.

TABLE 22

| | | Number of antenna ports for uplink |
|---|---|---|
| | Number | transmission (band A (carrier 1) + band B |
| | of Txs | (carrier 2) + band C (carrier 3)) |
| Case 1 | 1T + 1T + 0T | 1P + 0P + 0P, 0P + 1P + 0P, 1P + 1P + 0P |
| Case 2 | 0T + 2T + 0T | 0P + 2P + 0P, 0P + 1P + 0P |
| Case 3 | 2T + 0T + 0T | 2P + 0P + 0P, 1P + 0P + 0P |
| Case 4 | 0T + 0T + 2T | 0P + 0P + 2P, 0P + 0P + 1P |
| Case 5 | 1T + 0T + 1T | 1P + 0P + 0P, 0P + 0P + 1P, 1P + 0P + 1P |
| Case 6 | 0T + 1T + 1T | 0P + 1P + 0P, 0P + 0P + 1P, 0P + 1P + 1P |

### Embodiment 1-4

When mode 2 is configured, each band can support only transmission on one port. When 1Tx-1Tx switching is performed on any two bands, the UE cannot perform transmission on two carriers/any carrier for switching within a switching period.

Transmission on one port is performed on one band before switching, and the UE performs transmission on one port on another band after switching; or
transmission on one port is performed on one band before switching, and the UE performs transmission on one port on other two bands after switching; or
transmission on one port is performed on two bands before switching, and the UE performs transmission on one port on another band after switching. Specifically, combinations shown in Table 23 may exist.

TABLE 23

| | | |
|---|---|---|
| Case 1 | 1T + 1T + 0T | 1P + 0P + 0P, 0P + 1P + 0P, 1P + 1P + 0P |
| Case 5 | 1T + 0T + 1T | 1P + 0P + 0P, 0P + 0P + 1P, 1P + 0P + 1P |
| Case 6 | 0T + 1T + 1T | 0P + 1P + 0P, 0P + 0P + 1P, 0P + 1P + 1P |

### Embodiment 1-5

When mode 2 is configured and one Tx on each of two bands is switched to a third band:
transmission on one port is performed on one band before switching, and the UE performs transmission on one port on another band after switching; or
transmission on one port is performed on one band before switching, and the UE performs transmission on two ports on another band after switching.

### Embodiment 1-6

When mode 2 is configured and two Txs on one band are switched to other two bands:
transmission on one port is performed on one band before switching, and the UE performs transmission on one port on another band after switching; or
transmission on two ports is performed on one band before switching, and the UE performs transmission on one port on another band after switching.

### Embodiment 2-0

When N=4, M=2, and each band has one carrier, in a case that data cannot be simultaneously sent on different bands/carriers in mode 1, a mapping relationship between a Tx and an antenna port may be shown in Table 24:

TABLE 24

| | | Number of antenna ports for uplink |
|---|---|---|
| | | transmission (band A (carrier 1) + band B |
| | | (carrier 2) + band C (carrier 3)) + band D |
| | Number of Txs | (carrier 4) |
| Case 1 | 0T + 1T + 1T + 0T | 0P + 1P + 0P + 0P, 0P + 0P + 1P + 0P |
| Case 2 | 0T + 0T + 2T + 0T | 0P + 0P + 2P + 0P, 0P + 0P + 1P + 0P |
| Case 3 | 0T + 2T + 0T + 0T | 0P + 2P + 0P + 0P, 0P + 1P + 0P + 0P |
| Case 4 | 0T + 0T + 0T + 2T | 0P + 0P + 0P + 2P, 0P + 0P + 0P + 1P |
| Case 5 | 0T + 1T + 0T + 1T | 0P + 1P + 0P + 0P, 0P + 0P + 0P + 1P |
| Case 6 | 0T + 0T + 1T + 1T | 0P + 0P + 0P + 1P, 0P + 0P + 1P + 0P |
| Case 7 | 1T + 0T + 1T + 0T | 1P + 0P + 0P + 0P, 0P + 0P + 1P + 0P |
| Case 8 | 0T + 0T + 2T + 0T | 0P + 0P + 2P + 0P, 0P + 0P + 1P + 0P |
| Case 9 | 2T + 0T + 0T + 0T | 2P + 0P + 0P + 0P, 1P + 0P + 0P + 0P |
| Case 10 | 0T + 0T + 0T + 2T | 0P + 0P + 0P + 2P, 0P + 0P + 0P + 1P |
| Case 11 | 1T + 0T + 0T + 1T | 1P + 0P + 0P + 0P, 0P + 0P + 0P + 1P |
| Case 12 | 0T + 0T + 1T + 1T | 0P + 0P + 1P + 0P, 0P + 0P + 0P + 1P |
| Case 13 | 1T + 1T + 0T + 0T | 1P + 0P + 0P + 0P, 0P + 1P + 0P + 0P |
| Case 16 | 0T + 2T + 0T + 0T | 0P + 2P + 0P + 0P, 0P + 1P + 0P + 0P |
| Case 16 | 2T + 0T + 0T + 0T | 2P + 0P + 0P + 0P, 1P + 0P + 0P + 0P |
| Case 16 | 0T + 0T + 0T + 2T | 0P + 0P + 0P + 2P, 0P + 0P + 0P + 1P |
| Case 17 | 1T + 0T + 0T + 1T | 1P + 0P + 0P + 0P, 0P + 0P + 0P + 1P |
| Case 18 | 0T + 1T + 0T + 1T | 0P + 1P + 0P + 0P, 0P + 0P + 0P + 1P |
| Case 19 | 1T + 1T + 0T + 0T | 1P + 0P + 0P + 0P, 0P + 1P + 0P + 0P |
| Case 20 | 0T + 2T + 0T + 0T | 0P + 2P + 0P + 0P, 0P + 1P + 0P + 0P |
| Case 21 | 2T + 0T + 0T + 0T | 2P + 0P + 0P + 0P, 1P + 0P + 0P + 0P |
| Case 22 | 0T + 0T + 2T + 0T | 0P + 0P + 2P + 0P, 0P + 0P + 1P + 0P |
| Case 23 | 1T + 0T + 1T + 0T | 1P + 0P + 0P + 0P, 0P + 0P + 1P + 0P |
| Case 24 | 0T + 1T + 1T + 0T | 0P + 1P + 0P + 0P, 0P + 0P + 1P + 0P |

In a case that data may be simultaneously sent on different bands/carriers in mode 2, there may be the following combinations shown in Table 25:

TABLE 25

| | | Number of antenna ports for uplink |
|---|---|---|
| | | transmission (band A (carrier 1) + band B |
| | | (carrier 2) + band C (carrier 3)) + band D |
| | Number of Txs | (carrier 4) |
| Case 1 | 0T + 1T + 1T + 0T | 1P + 0P + 0P + 0P, 0P + 1P + 0P + 0P, 0P + 1P + 1P + 0P |
| Case 2 | 0T + 0T + 2T + 0T | 0P + 2P + 0P + 0P, 0P + 1P + 0P + 0P |
| Case 3 | 0T + 2T + 0T + 0T | 2P + 0P + 0P + 0P, 1P + 0P + 0P + 0P |
| Case 4 | 0T + 0T + 0T + 2T | 0P + 0P + 2P + 0P, 0P + 0P + 1P + 0P |
| Case 5 | 0T + 1T + 0T + 1T | 1P + 0P + 0P + 0P, 0P + 0P + 1P + 0P, 0P + 1P + 0P + 1P |
| Case 6 | 0T + 0T + 1T + 1T | 0P + 0P + 1P + 0P, 0P + 0P + 0P + 1P, 0P + 0P + 1P + 1P |
| Case 7 | 1T + 0T + 1T + 0T | 1P + 0P + 0P + 0P, 0P + 0P + 1P + 0P, 1P + 0P + 1P + 0P |
| Case 8 | 0T + 0T + 2T + 0T | 0P + 0P + 2P + 0P, 0P + 0P + 1P + 0P |
| Case 9 | 2T + 0T + 0T + 0T | 2P + 0P + 0P + 0P, 1P + 0P + 0P + 0P |
| Case 10 | 0T + 0T + 0T + 2T | 0P + 0P + 0P + 2P, 0P + 0P + 0P + 1P |
| Case 11 | 1T + 0T + 0T + 1T | 1P + 0P + 0P + 0P, 0P + 0P + 0P + 1P, 1P + 0P + 0P + 1P |
| Case 12 | 0T + 0T + 1T + 1T | 0P + 0P + 1P + 0P, 0P + 0P + 0P + 1P, 0P + 0P + 1P + 1P |
| Case 13 | 1T + 1T + 0T + 0T | 1P + 0P + 0P + 0P, 0P + 1P + 0P + 0P, 1P + 1P + 0P + 0P |
| Case 16 | 0T + 2T + 0T + 0T | 0P + 2P + 0P + 0P, 0P + 1P + 0P + 0P |
| Case 16 | 2T + 0T + 0T + 0T | 2P + 0P + 0P + 0P, 1P + 0P + 0P + 0P |
| Case 16 | 0T + 0T + 0T + 2T | 0P + 0P + 0P + 2P, 0P + 0P + 0P + 1P |
| Case 17 | 1T + 0T + 0T + 1T | 1P + 0P + 0P + 0P, 0P + 0P + 0P + 1P, 1P + 0P + 0P + 1P |
| Case 18 | 0T + 1T + 0T + 1T | 0P + 1P + 0P + 0P, 0P + 0P + 0P + 1P, 0P + 1P + 0P + 1P |
| Case 19 | 1T + 1T + 0T + 0T | 1P + 0P + 0P + 0P, 0P + 1P + 0P + 0P, 1P + 1P + 0P + 0P |
| Case 20 | 0T + 2T + 0T + 0T | 0P + 2P + 0P + 0P, 0P + 1P + 0P + 0P |
| Case 21 | 2T + 0T + 0T + 0T | 2P + 0P + 0P + 0P, 1P + 0P + 0P + 0P |
| Case 22 | 0T + 0T + 2T + 0T | 0P + 0P + 2P + 0P, 0P + 0P + 1P + 0P |
| Case 23 | 1T + 0T + 1T + 0T | 1P + 0P + 0P + 0P, 0P + 0P + 1P + 0P, 1P + 0P + 1P + 0P |
| Case 24 | 0T + 1T + 1T + 0T | 0P + 1P + 0P + 0P, 0P + 0P + 1P + 0P, 0P + 1P + 1P + 0P |

In addition to the foregoing cases on two bands and three bands, Tx switching on four bands include a case on four bands, that is, one Tx on each of two bands is switched to the other two bands. The four bands support only transmission on one port.

### Embodiment 2-1

When mode 1 is configured and one Tx on each of two bands is switched to other two bands, transmission on one port is performed on one band before switching, and the UE performs transmission on one port on another band after switching. Details may be shown in Table 26.

TABLE 26

| | | Number of antenna ports for uplink |
|---|---|---|
| | | transmission (band A (carrier 1) + band B |
| | | (carrier 2) + band C (carrier 3)) + band D |
| | Number of Txs | (carrier 4) |
| Case 3 | 0T + 2T + 0T + 0T | 2P + 0P + 0P + 0P, 1P + 0P + 0P + 0P |
| Case 6 | 0T + 0T + 1T + 1T | 0P + 0P + 1P + 0P, 0P + 0P + 0P + 1P |

### Embodiment 2-2

When mode 2 is configured and one Tx on each of two bands is switched to other two bands, transmission on one port is performed on two bands before switching, and the UE performs transmission on two ports on other two bands after switching. Details may be shown in Table 27.

TABLE 27

| | | Number of antenna ports for uplink |
|---|---|---|
| | | transmission (band A (carrier 1) + band B |
| | | (carrier 2) + band C (carrier 3)) + band D |
| | Number of Txs | (carrier 4) |
| Case 3 | 0T + 2T + 0T + 0T | 2P + 0P + 0P + 0P, 1P + 0P + 0P + 0P, 1P + 1P + 0P + 0P |
| Case 6 | 0T + 0T + 1T + 1T | 0P + 0P + 1P + 0P, 0P + 0P + 0P + 1P, 0P + 0P + 1P + 1P |

Referring to FIG. 4, FIG. 4 is a structural diagram of a capability information reporting apparatus according to an embodiment of this application. As shown in FIG. 4, the apparatus includes:
a reporting module 401, configured to report capability information related to Tx switching, where the capability information includes at least one of the following:
a capability of supporting parallel Tx switching;
a capability of supporting serial Tx switching; and
a maximum number of times of switching within a preset period.

Optionally, the capability information further includes at least one of the following:
a frequency domain resource combination supporting Tx switching;
a switching period of Tx switching; and
a type of supported Tx switching.

Optionally, the frequency domain resource combination supporting Tx switching is a frequency domain resource pair, and in a case that the terminal triggers Tx switching within a frequency domain resource pair in N frequency domain resource pairs, a period for which the terminal completes Tx switching in the N frequency domain resource pairs includes one of the following:
a minimum period in N switching periods;
a maximum period in the N switching periods;
a weighted sum of the N switching periods; and
a total period of the N switching periods, where
the N switching periods are switching periods respectively corresponding to the N frequency domain resource pairs, and N is an integer greater than 1.

Optionally, in a case that transmission performed by the terminal after Tx switching is transmission on one antenna port, the period for which the terminal completes Tx switching in the N frequency domain resource pairs includes the minimum period in the N switching periods; and/or
in a case that the terminal supports parallel Tx switching between different frequency domain resources, the period for which the terminal completes Tx switching in the N frequency domain resource pairs includes the minimum period in the N switching periods.

Optionally, in a case that transmission performed by the terminal after Tx switching includes at least one of transmission on a plurality of antenna ports and transmission on a plurality of frequency domain resources, the period for which the terminal completes Tx switching in the N frequency domain resource pairs includes the maximum period in the N switching periods; and/or
in a case that the terminal supports parallel Tx switching between different frequency domain resources, the period for which the terminal completes Tx switching in the N frequency domain resource pairs includes the maximum period in the N switching periods.

Optionally, in a case that transmission performed by the terminal after Tx switching is at least one of transmission on a plurality of antenna ports and transmission on a plurality of frequency domain resources, the period for which the terminal completes Tx switching in the N frequency domain resource pairs includes the total period of the N switching periods; and/or
in a case that the terminal supports serial Tx switching between different frequency domain resources, the period for which the terminal completes Tx switching in the N frequency domain resource pairs includes the total period of the N switching periods.

Optionally, in the frequency domain resource combination supporting Tx switching, Tx switching is supported between at least two frequency domain resources.

Optionally, the switching period of Tx switching includes:
a switching period of M frequency domain resources in one or more frequency domain resource combinations supporting Tx switching, where M is a positive integer; and
the M frequency domain resources include one of the following:
a frequency domain resource on which transmission or scheduling by the terminal occurs before and/or after Tx switching;
a frequency domain resource on which transmission or scheduling by the terminal changes before and after Tx switching;
all frequency domain resources in the frequency domain resource combination supporting Tx switching;
a frequency domain resource configured through carrier aggregation in the frequency domain resource combination supporting Tx switching; and
a frequency domain resource activated through carrier aggregation in the frequency domain resource combination supporting Tx switching.

Optionally, the capability of supporting parallel Tx switching includes at least one of the following:
allowing switching periods of different Tx switching to at least partially overlap;
allowing an interval between switching periods of different Tx switching to be less than or equal to a first preset threshold;
allowing another Tx to switch or to be triggered switching after Tx switching is triggered;
allowing another Tx to switch or to be triggered switching before switched transmission starts or ends; and
allowing another Tx to switch or to be triggered switching after switched transmission starts.

Optionally, the allowing another Tx to switch or to be triggered switching after Tx switching is triggered includes:
allowing another Tx to switch or to be triggered switching within a first predetermined period after Tx switching is triggered; and/or
the allowing another Tx to switch or to be triggered switching before switched transmission starts or ends includes:
allowing another Tx to switch or to be triggered switching within a second predetermined period before switched transmission starts or ends; and/or
the allowing another Tx to switch or to be triggered switching after switched transmission starts includes:
allowing another Tx to switch or to be triggered switching within a third predetermined period after switched transmission starts.

Optionally, the capability information further includes at least one of the following:
the first predetermined period, the second predetermined period, and the third predetermined period.

Optionally, the capability of supporting serial Tx switching includes at least one of the following:
switching periods of different Tx switching do not overlap;
allowing an interval between switching periods of different Tx switching to be greater than or equal to a second preset threshold;
disallowing another Tx to switch or to be triggered switching after Tx switching is triggered;
disallowing another Tx to switch or to be triggered switching before switched transmission starts or ends; and
disallowing another Tx to switch or to be triggered switching after switched transmission starts.

Optionally, the disallowing another Tx to switch or to be triggered switching after Tx switching is triggered includes:
disallowing another Tx to switch or to be triggered switching within a fourth predetermined period after Tx switching is triggered; and/or
the disallowing another Tx to switch or to be triggered switching before switched transmission starts or ends includes:
disallowing another Tx to switch or to be triggered switching within a fifth predetermined period before switched transmission starts or ends; and/or
the disallowing another Tx to switch or to be triggered switching after switched transmission starts includes:
disallowing another Tx to switch or to be triggered switching within a sixth predetermined period after switched transmission starts.

Optionally, the capability information further includes at least one of the following:
the fourth predetermined period, the fifth predetermined period, and the sixth predetermined period.

Optionally, in a case that Tx switching is triggered on X frequency domain resources,
the terminal cannot perform transmission or cannot be scheduled on a first target frequency domain resource within a switching period of the X frequency domain resources, and the first target frequency domain resource includes the X frequency domain resources or the first target frequency domain resource includes at least one of the following:
a frequency domain resource corresponding to transmission before switching;
a frequency domain resource corresponding to switched transmission;
a frequency domain resource on which transmission changes before switching; and
a frequency domain resource on which transmission changes after switching; and/or
in a case that Tx switching is triggered on X frequency domain resources,
the terminal cannot perform transmission or cannot be scheduled on a second target frequency domain resource within a switching period of the m^{th} frequency domain resource pair in the X frequency domain resources, and the second target frequency domain resource includes the m^{th} frequency domain resource pair or the second target frequency domain resource includes at least one of the following in the m^{th} frequency domain resource pair:
a frequency domain resource on which transmission changes before switching; and
a frequency domain resource on which transmission changes after switching, where
X and m are positive integers.

Optionally, that Tx switching is triggered on the X frequency domain resources includes at least one of the following:
Tx switching is simultaneously triggered on the X frequency domain resources;
Tx switching is triggered within a preset period range on the X frequency domain resources; and
a preset condition is met when Tx switching is triggered on the X frequency domain resources.

Optionally, after O times of switching, switching is allowed only after at least a seventh predetermined period elapses; or
after O times of switching, no further switching is expected within an eighth predetermined period, where
O is a positive integer.

Optionally, the seventh predetermined period or the eighth predetermined period is one slot, and a subcarrier spacing SCS corresponding to the one slot is a maximum or minimum SCS in a switching process, where the maximum or minimum SCS includes one of the following:
a maximum or minimum SCS in SCSs of carriers or bandwidth parts BWPs that participate in switching;
a maximum or minimum SCS of a band that participates in switching;
a maximum or minimum SCS in SCSs corresponding to frequency domain resources or of N bands corresponding to switching, where N is an integer greater than 1; and
a maximum or minimum SCS in SCSs of all bands, carriers, or BWPs that are configured for the terminal.

Optionally, switching that meets at least one of the following is one time of switching:
time points at which Tx switching is triggered are the same;
downlink control information DCI triggered by Tx switching is the same;
target frequency domain resources after switching are the same;
source frequency domain resources before switching are the same; and
start time points of target uplink transmission after switching are the same or within a ninth predetermined period.

Optionally, an event that meets at least one of the following is Tx switching:
an index of a frequency domain resource for transmission changes;
a number of Txs, antenna ports, layers, or resource pools for transmission changes; and
a number of frequency domain resources for transmission changes.

Optionally, the switching period of Tx switching is associated with at least one of the following:
a number of antenna ports for transmission and an index of an antenna port for transmission.

Optionally, the frequency domain resource includes one of the following:
a band, a carrier, a BWP, and a resource pool.

The foregoing capability information reporting apparatus can improve transmission performance of the terminal.

The capability information reporting apparatus in this embodiment of this application may be an electronic device, for example, an electronic device with an operating system, or may be a component in the electronic device, for example, an integrated circuit or a chip. The electronic device may be a terminal, or another device other than the terminal. For example, the terminal may include but is not limited to the type of the terminal enumerated in the embodiments of this application. The another device may be a server, a network attached storage (NAS), or the like. This is not specifically limited in the embodiments of this application.

The capability information reporting apparatus provided in this embodiment of this application can implement the processes implemented in the method embodiment shown in FIG. 2, and achieve a same technical effect. To avoid repetition, details are not described herein again.

Referring to FIG. 5, FIG. 5 is a structural diagram of a capability information receiving apparatus according to an embodiment of this application. As shown in FIG. 5, the apparatus includes:
a receiving module 501, configured to receive capability information that is related to Tx switching and that is reported by a terminal, where the capability information includes at least one of the following:
a capability of supporting parallel Tx switching;
a capability of supporting serial Tx switching; and
a maximum number of times of switching within a preset period.

Optionally, the capability information further includes at least one of the following:
a frequency domain resource combination supporting Tx switching;
a switching period of Tx switching; and
a type of supported Tx switching.

Optionally, the frequency domain resource combination supporting Tx switching is a frequency domain resource pair, and in a case that the terminal triggers Tx switching within a frequency domain resource pair in N frequency domain resource pairs, a period for which the terminal completes Tx switching in the N frequency domain resource pairs includes one of the following:
a minimum period in N switching periods;
a maximum period in the N switching periods;
a weighted sum of the N switching periods; and
a total period of the N switching periods, where
the N switching periods are switching periods respectively corresponding to the N frequency domain resource pairs, and N is an integer greater than 1.

Optionally, in a case that transmission performed by the terminal after Tx switching is transmission on one antenna port, the period for which the terminal completes Tx switching in the N frequency domain resource pairs includes the minimum period in the N switching periods; and/or
in a case that the terminal supports parallel Tx switching between different frequency domain resources, the period for which the terminal completes Tx switching in the N frequency domain resource pairs includes the minimum period in the N switching periods.

Optionally, in a case that transmission performed by the terminal after Tx switching includes at least one of transmission on a plurality of antenna ports and transmission on a plurality of frequency domain resources, the period for which the terminal completes Tx switching in the N frequency domain resource pairs includes the maximum period in the N switching periods; and/or
in a case that the terminal supports parallel Tx switching between different frequency domain resources, the period for which the terminal completes Tx switching in the N frequency domain resource pairs includes the maximum period in the N switching periods.

Optionally, in a case that transmission performed by the terminal after Tx switching is at least one of transmission on a plurality of antenna ports and transmission on a plurality of frequency domain resources, the period for which the terminal completes Tx switching in the N frequency domain resource pairs includes the total period of the N switching periods; and/or
in a case that the terminal supports serial Tx switching between different frequency domain resources, the period for which the terminal completes Tx switching in the N frequency domain resource pairs includes the total period of the N switching periods.

Optionally, in the frequency domain resource combination supporting Tx switching, Tx switching is supported between at least two frequency domain resources.

Optionally, the switching period of Tx switching includes:
a switching period of M frequency domain resources in one or more frequency domain resource combinations supporting Tx switching, where M is a positive integer; and
the M frequency domain resources include one of the following:
a frequency domain resource on which transmission or scheduling by the terminal occurs before and/or after Tx switching;
a frequency domain resource on which transmission or scheduling by the terminal changes before and after Tx switching;
all frequency domain resources in the frequency domain resource combination supporting Tx switching;
a frequency domain resource configured through carrier aggregation in the frequency domain resource combination supporting Tx switching; and
a frequency domain resource activated through carrier aggregation in the frequency domain resource combination supporting Tx switching.

Optionally, the capability of supporting parallel Tx switching includes at least one of the following:
allowing switching periods of different Tx switching to at least partially overlap;
allowing an interval between switching periods of different Tx switching to be less than or equal to a first preset threshold;
allowing another Tx to switch or to be triggered switching after Tx switching is triggered;
allowing another Tx to switch or to be triggered switching before switched transmission starts or ends; and
allowing another Tx to switch or to be triggered switching after switched transmission starts.

Optionally, the allowing another Tx to switch or to be triggered switching after Tx switching is triggered includes:
allowing another Tx to switch or to be triggered switching within a first predetermined period after Tx switching is triggered; and/or
the allowing another Tx to switch or to be triggered switching before switched transmission starts or ends includes:
allowing another Tx to switch or to be triggered switching within a second predetermined period before switched transmission starts or ends; and/or
the allowing another Tx to switch or to be triggered switching after switched transmission starts includes:
allowing another Tx to switch or to be triggered switching within a third predetermined period after switched transmission starts.

Optionally, the capability information further includes at least one of the following:
the first predetermined period, the second predetermined period, and the third predetermined period.

Optionally, the capability of supporting serial Tx switching includes at least one of the following:
switching periods of different Tx switching do not overlap;
allowing an interval between switching periods of different Tx switching to be greater than or equal to a second preset threshold;
disallowing another Tx to switch or to be triggered switching after Tx switching is triggered;
disallowing another Tx to switch or to be triggered switching before switched transmission starts or ends; and
disallowing another Tx to switch or to be triggered switching after switched transmission starts.

Optionally, the disallowing another Tx to switch or to be triggered switching after Tx switching is triggered includes:
disallowing another Tx to switch or to be triggered switching within a fourth predetermined period after Tx switching is triggered; and/or
the disallowing another Tx to switch or to be triggered switching before switched transmission starts or ends includes:
disallowing another Tx to switch or to be triggered switching within a fifth predetermined period before switched transmission starts or ends; and/or
the disallowing another Tx to switch or to be triggered switching after switched transmission starts includes:
disallowing another Tx to switch or to be triggered switching within a sixth predetermined period after switched transmission starts.

Optionally, the capability information further includes at least one of the following:
the fourth predetermined period, the fifth predetermined period, and the sixth predetermined period.

Optionally, in a case that Tx switching is triggered on X frequency domain resources,
the terminal cannot perform transmission or cannot be scheduled on a first target frequency domain resource within a switching period of the X frequency domain resources, and the first target frequency domain resource includes the X frequency domain resources or the first target frequency domain resource includes at least one of the following:
a frequency domain resource corresponding to transmission before switching;
a frequency domain resource corresponding to switched transmission;
a frequency domain resource on which transmission changes before switching; and
a frequency domain resource on which transmission changes after switching; and/or
in a case that Tx switching is triggered on X frequency domain resources,
the terminal cannot perform transmission or cannot be scheduled on a second target frequency domain resource within a switching period of the m^{th} frequency domain resource pair in the X frequency domain resources, and the second target frequency domain resource includes the m^{th} frequency domain resource pair or the second target frequency domain resource includes at least one of the following in the m^{th} frequency domain resource pair:
a frequency domain resource on which transmission changes before switching; and
a frequency domain resource on which transmission changes after switching, where
X and m are positive integers.

Optionally, that Tx switching is triggered on the X frequency domain resources includes at least one of the following:
Tx switching is simultaneously triggered on the X frequency domain resources;
Tx switching is triggered within a preset period range on the X frequency domain resources; and
a preset condition is met when Tx switching is triggered on the X frequency domain resources.

Optionally, after O times of switching, switching is allowed only after at least a seventh predetermined period elapses; or
after O times of switching, no further switching is expected within an eighth predetermined period, where
O is a positive integer.

Optionally, the seventh predetermined period or the eighth predetermined period is one slot, and a subcarrier spacing SCS corresponding to the one slot is a maximum or minimum SCS in a switching process, where the maximum or minimum SCS includes one of the following:
a maximum or minimum SCS in SCSs of carriers or bandwidth parts BWPs that participate in switching;
a maximum or minimum SCS of a band that participates in switching;
a maximum or minimum SCS in SCSs corresponding to frequency domain resources or of N bands corresponding to switching, where N is an integer greater than 1; and
a maximum or minimum SCS in SCSs of all bands, carriers, or BWPs that are configured for the terminal.

Optionally, switching that meets at least one of the following is one time of switching:
time points at which Tx switching is triggered are the same;
downlink control information DCI triggered by Tx switching is the same;
target frequency domain resources after switching are the same;
source frequency domain resources before switching are the same; and
start time points of target uplink transmission after switching are the same or within a ninth predetermined period.

Optionally, an event that meets at least one of the following is Tx switching:
an index of a frequency domain resource for transmission changes;
a number of Txs, antenna ports, layers, or resource pools for transmission changes; and
a number of frequency domain resources for transmission changes.

Optionally, the switching period of Tx switching is associated with at least one of the following:
a number of antenna ports for transmission and an index of an antenna port for transmission.

Optionally, the frequency domain resource includes one of the following:
a band, a carrier, a BWP, and a resource pool.

The capability information receiving apparatus can transmit performance of the terminal.

The capability information receiving apparatus in this embodiment of this application may be an electronic device, for example, an electronic device with an operating system, or may be a component in the electronic device, for example, an integrated circuit or a chip. The electronic device may be a network side device, or may be another device other than the network side device. For example, the network side device may include but is not limited to the type of the network side device enumerated in the embodiments of this application. The another device may be a server, a network attached storage (NAS), or the like. This is not specifically limited in the embodiments of this application.

The capability information receiving apparatus provided in this embodiment of this application can implement the processes implemented in the method embodiment shown in FIG. 3, and achieve a same technical effect. To avoid repetition, details are not described herein again.

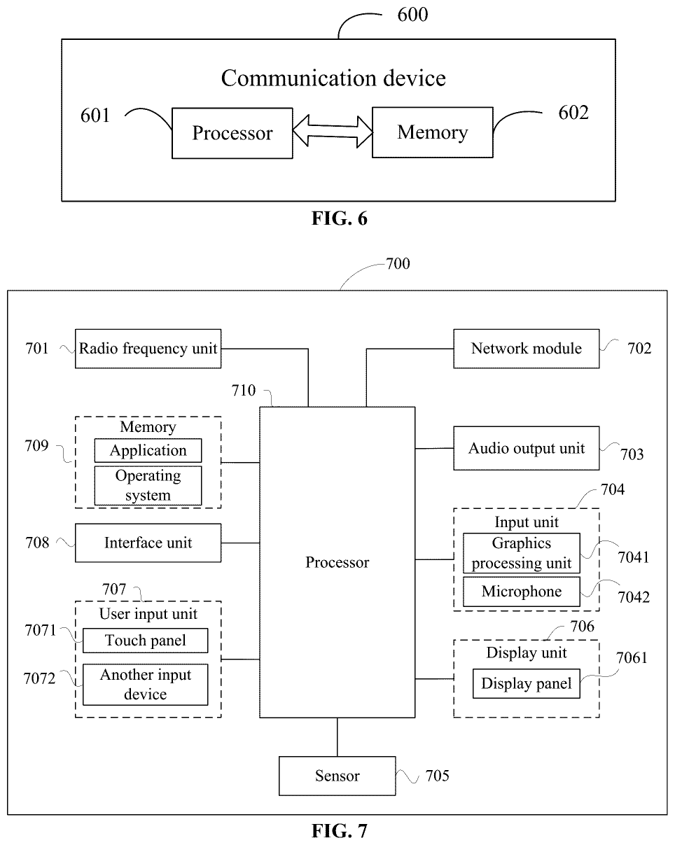

Optionally, as shown in FIG. 6, an embodiment of this application further provides a communication device 600, including a processor 601 and a memory 602. The memory 602 stores a program or an instruction that can be run on the processor 601. For example, when the communication device 600 is a terminal, the program or the instruction is executed by the processor 601 to implement the steps of the foregoing capability information reporting method embodiment, and a same technical effect can be achieved. When the communication device 600 is a network side device or an SL terminal, the program or the instruction is executed by the processor 601 to implement the steps of the foregoing capability information receiving method embodiment, and a same technical effect can be achieved. To avoid repetition, details are not described herein again.

An embodiment of this application further provides a terminal, including a processor and a communication interface. The communication interface is configured to report capability information related to Tx switching, where the capability information includes at least one of the following: a capability of supporting parallel Tx switching; a capability of supporting serial Tx switching; and a maximum number of times of switching within a preset period. This terminal embodiment corresponds to the foregoing method embodiment on the terminal side. Each implementation process and implementation of the foregoing method embodiment may be applicable to this terminal embodiment, and a same technical effect can be achieved. Specifically, FIG. 7 is a schematic diagram of a hardware structure of a terminal according to an embodiment of this application.

A terminal 700 includes but is not limited to components such as a radio frequency unit 701, a network module 702, an audio output unit 703, an input unit 704, a sensor 705, a display unit 706, a user input unit 707, an interface unit 708, a memory 709, and a processor 710.

A person skilled in the art can understand that the terminal 700 may further include the power supply (for example, a battery) that supplies power to each component. The power supply may be logically connected to the processor 710 by using a power supply management system, so as to manage functions such as charging, discharging, and power consumption by using the power supply management system. The terminal structure shown in FIG. 7 constitutes no limitation on the terminal, and the terminal may include more or fewer components than those shown in the figure, or combine some components, or have different component arrangements. Details are not described herein.

It should be understood that, in this embodiment of this application, the input unit 704 may include a graphics processing unit (GPU) 7041 and a microphone 7042, and the graphics processing unit 7041 processes image data of a still image or a video that is obtained by an image capturing apparatus (for example, a camera) in a video capturing mode or an image capturing mode. The display unit 706 may include a display panel 7061. The display panel 7061 may be configured in a form such as a liquid crystal display or an organic light-emitting diode. The user input unit 707 includes at least one of a touch panel 7071 and another input device 7072. The touch panel 7071 is also referred to as a touchscreen. The touch panel 7071 may include two parts: a touch detection apparatus and a touch controller. The another input device 7072 may include but is not limited to a physical keyboard, a functional button (such as a volume control button or a power on/off button), a trackball, a mouse, and a joystick. Details are not described herein.

In this embodiment of this application, after receiving downlink data from a network side device, the radio frequency unit 701 may transmit the downlink data to the processor 710 for processing. In addition, the radio frequency unit 701 may send uplink data to the network side device. Usually, the radio frequency unit 701 includes but is not limited to an antenna, an amplifier, a transceiver, a coupler, a low noise amplifier, a duplexer, and the like.

The memory 709 may be configured to store a software program or an instruction and various data. The memory 709 may mainly include a first storage area for storing a program or an instruction and a second storage area for storing data. The first storage area may store an operating system, and an application or an instruction required by at least one function (for example, a sound playing function or an image playing function). In addition, the memory 709 may be a volatile memory or a non-volatile memory, or the memory 709 may include a volatile memory and a non-volatile memory. The nonvolatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM), a static random access memory (SRAM), a dynamic random access memory (DRAM), a synchronous dynamic random access memory (SDRAM), a double data rate synchronous dynamic random access memory (DDRSDRAM), an enhanced synchronous dynamic random access memory (ESDRAM), a synchlink dynamic random access memory (SLDRAM), and a direct rambus random access memory (DRRAM). The memory 709 in this embodiment of this application includes but is not limited to these memories and a memory of any other proper type.

The processor 710 may include one or more processing units. Optionally, an application processor and a modem processor are integrated into the processor 710. The application processor mainly processes an operating system, a user interface, an application, and the like. The modem processor mainly processes a wireless communication signal, for example, a baseband processor. It can be understood that, alternatively, the modem processor may not be integrated into the processor 710.

The radio frequency unit 701 is configured to report capability information related to Tx switching, where the capability information includes at least one of the following:
a capability of supporting parallel Tx switching;
a capability of supporting serial Tx switching; and
a maximum number of times of switching within a preset period.

Optionally, the capability information further includes at least one of the following:
a frequency domain resource combination supporting Tx switching;
a switching period of Tx switching; and
a type of supported Tx switching.

Optionally, the frequency domain resource combination supporting Tx switching is a frequency domain resource pair, and in a case that the terminal triggers Tx switching within a frequency domain resource pair in N frequency domain resource pairs, a period for which the terminal completes Tx switching in the N frequency domain resource pairs includes one of the following:
a minimum period in N switching periods;
a maximum period in the N switching periods;
a weighted sum of the N switching periods; and
a total period of the N switching periods, where
the N switching periods are switching periods respectively corresponding to the N frequency domain resource pairs, and N is an integer greater than 1.

Optionally, in a case that transmission performed by the terminal after Tx switching is transmission on one antenna port, the period for which the terminal completes Tx switching in the N frequency domain resource pairs includes the minimum period in the N switching periods; and/or
in a case that the terminal supports parallel Tx switching between different frequency domain resources, the period for which the terminal completes Tx switching in the N frequency domain resource pairs includes the minimum period in the N switching periods.

Optionally, in a case that transmission performed by the terminal after Tx switching includes at least one of transmission on a plurality of antenna ports and transmission on a plurality of frequency domain resources, the period for which the terminal completes Tx switching in the N frequency domain resource pairs includes the maximum period in the N switching periods; and/or
in a case that the terminal supports parallel Tx switching between different frequency domain resources, the period for which the terminal completes Tx switching in the N frequency domain resource pairs includes the maximum period in the N switching periods.

Optionally, in a case that transmission performed by the terminal after Tx switching is at least one of transmission on a plurality of antenna ports and transmission on a plurality of frequency domain resources, the period for which the terminal completes Tx switching in the N frequency domain resource pairs includes the total period of the N switching periods; and/or
in a case that the terminal supports serial Tx switching between different frequency domain resources, the period for which the terminal completes Tx switching in the N frequency domain resource pairs includes the total period of the N switching periods.

Optionally, in the frequency domain resource combination supporting Tx switching, Tx switching is supported between at least two frequency domain resources.

Optionally, the switching period of Tx switching includes:
a switching period of M frequency domain resources in one or more frequency domain resource combinations supporting Tx switching, where M is a positive integer; and
the M frequency domain resources include one of the following:
a frequency domain resource on which transmission or scheduling by the terminal occurs before and/or after Tx switching;
a frequency domain resource on which transmission or scheduling by the terminal changes before and after Tx switching;
all frequency domain resources in the frequency domain resource combination supporting Tx switching;
a frequency domain resource configured through carrier aggregation in the frequency domain resource combination supporting Tx switching; and
a frequency domain resource activated through carrier aggregation in the frequency domain resource combination supporting Tx switching.

Optionally, the capability of supporting parallel Tx switching includes at least one of the following:
allowing switching periods of different Tx switching to at least partially overlap;
allowing an interval between switching periods of different Tx switching to be less than or equal to a first preset threshold;
allowing another Tx to switch or to be triggered switching after Tx switching is triggered;
allowing another Tx to switch or to be triggered switching before switched transmission starts or ends; and
allowing another Tx to switch or to be triggered switching after switched transmission starts.

Optionally, the allowing another Tx to switch or to be triggered switching after Tx switching is triggered includes:
allowing another Tx to switch or to be triggered switching within a first predetermined period after Tx switching is triggered; and/or
the allowing another Tx to switch or to be triggered switching before switched transmission starts or ends includes:
allowing another Tx to switch or to be triggered switching within a second predetermined period before switched transmission starts or ends; and/or
the allowing another Tx to switch or to be triggered switching after switched transmission starts includes:
allowing another Tx to switch or to be triggered switching within a third predetermined period after switched transmission starts.

Optionally, the capability information further includes at least one of the following:
the first predetermined period, the second predetermined period, and the third predetermined period.

Optionally, the capability of supporting serial Tx switching includes at least one of the following:
switching periods of different Tx switching do not overlap;
allowing an interval between switching periods of different Tx switching to be greater than or equal to a second preset threshold;
disallowing another Tx to trigger switching after Tx switching is triggered;
disallowing another Tx to trigger switching before switched transmission starts or ends; and
disallowing another Tx to trigger switching after switched transmission starts.

Optionally, the disallowing another Tx to trigger switching after Tx switching is triggered includes:
disallowing another Tx to trigger switching within a fourth predetermined period after Tx switching is triggered; and/or
the disallowing another Tx to trigger switching before switched transmission starts or ends includes:
disallowing another Tx to trigger switching within a fifth predetermined period before switched transmission starts or ends; and/or
the disallowing another Tx to trigger switching after switched transmission starts includes:
disallowing another Tx to trigger switching within a sixth predetermined period after switched transmission starts.

Optionally, the capability information further includes at least one of the following:
the fourth predetermined period, the fifth predetermined period, and the sixth predetermined period.

Optionally, in a case that Tx switching is triggered on X frequency domain resources,
the terminal cannot perform transmission or cannot be scheduled on a first target frequency domain resource within a switching period of the X frequency domain resources, and the first target frequency domain resource includes the X frequency domain resources or the first target frequency domain resource includes at least one of the following:
a frequency domain resource corresponding to transmission before switching;
a frequency domain resource corresponding to switched transmission;
a frequency domain resource on which transmission changes before switching; and
a frequency domain resource on which transmission changes after switching; and/or
in a case that Tx switching is triggered on X frequency domain resources,
the terminal cannot perform transmission or cannot be scheduled on a second target frequency domain resource within a switching period of the m^{th} frequency domain resource pair in the X frequency domain resources, and the second target frequency domain resource includes the m^{th} frequency domain resource pair or the second target frequency domain resource includes at least one of the following in the m^{th} frequency domain resource pair:
a frequency domain resource on which transmission changes before switching; and
a frequency domain resource on which transmission changes after switching, where
X and m are positive integers.

Optionally, that Tx switching is triggered on the X frequency domain resources includes at least one of the following:
Tx switching is simultaneously triggered on the X frequency domain resources;
Tx switching is triggered within a preset period range on the X frequency domain resources; and
a preset condition is met when Tx switching is triggered on the X frequency domain resources.

Optionally, after O times of switching, switching is allowed only after at least a seventh predetermined period elapses; or
after O times of switching, no further switching is expected within an eighth predetermined period, where
O is a positive integer.

Optionally, the seventh predetermined period or the eighth predetermined period is one slot, and a subcarrier spacing SCS corresponding to the one slot is a maximum or minimum SCS in a switching process, where the maximum or minimum SCS includes one of the following:
a maximum or minimum SCS in SCSs of carriers or bandwidth parts BWPs that participate in switching;
a maximum or minimum SCS of a band that participates in switching;
a maximum or minimum SCS in SCSs corresponding to frequency domain resources or of N bands corresponding to switching, where N is an integer greater than 1; and
a maximum or minimum SCS in SCSs of all bands, carriers, or BWPs that are configured for the terminal.

Optionally, switching that meets at least one of the following is one time of switching:
time points at which Tx switching is triggered are the same;
downlink control information DCI triggered by Tx switching is the same;
target frequency domain resources after switching are the same;
source frequency domain resources before switching are the same; and
start time points of target uplink transmission after switching are the same or within a ninth predetermined period.

Optionally, an event that meets at least one of the following is Tx switching:
an index of a frequency domain resource for transmission changes;
a number of Txs, antenna ports, layers, or resource pools for transmission changes; and
a number of frequency domain resources for transmission changes.

Optionally, the switching period of Tx switching is associated with at least one of the following:
a number of antenna ports for transmission and an index of an antenna port for transmission.

Optionally, the frequency domain resource includes one of the following:
a band, a carrier, a BWP, and a resource pool.

The foregoing terminal can improve transmission performance of the terminal.

An embodiment of this application further provides a communication device, including a processor and a communication interface. The communication interface is configured to receive capability information that is related to Tx switching and that is reported by a terminal, where the capability information includes at least one of the following: a capability of supporting parallel Tx switching; a capability of supporting serial Tx switching; and a maximum number of times of switching within a preset period. This embodiment on the network side device side corresponds to the foregoing method embodiment of the communication device. Each implementation process and implementation of the foregoing method embodiment may be applicable to the embodiment on the network side device side, and a same technical effect can be achieved.

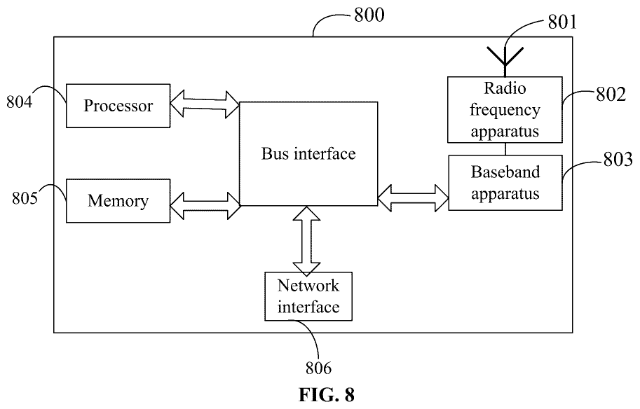

Specifically, an embodiment of this application further provides a communication device. As shown in FIG. 8, a network side device 800 includes an antenna 801, a radio frequency apparatus 802, a baseband apparatus 803, a processor 804, and a memory 805. The antenna 801 is connected to the radio frequency apparatus 802. In an uplink direction, the radio frequency apparatus 802 receives information by using the antenna 801, and sends the received information to the baseband apparatus 803 for processing. In a downlink direction, the baseband apparatus 803 processes information that needs to be sent, and sends processed information to the radio frequency apparatus 802. The radio frequency apparatus 802 processes the received information, and sends processed information by using the antenna 801.

In the foregoing embodiment, the method performed by the network side device may be implemented in the baseband apparatus 803. The baseband apparatus 803 includes a baseband processor.

The baseband apparatus 803 may include, for example, at least one baseband board, where a plurality of chips are disposed on the baseband board. As shown in FIG. 8, one chip is, for example, the baseband processor, is connected to the memory 805 through a bus interface, to invoke a program in the memory 805 to perform the operations of the network device shown in the foregoing method embodiment.

The network side device may further include a network interface 806, and the interface is, for example, a common public radio interface (CPRI).

Specifically, the network side device 800 in this embodiment of the present invention further includes an instruction or a program that is stored in the memory 805 and that can be run on the processor 804. The processor 804 invokes the instruction or the program in the memory 805 to perform the method performed by the modules shown in FIG. 4, and a same technical effect is achieved. To avoid repetition, details are not described herein again.

The radio frequency apparatus 802 is configured to receive capability information that is related to Tx switching and that is reported by a terminal, where the capability information includes at least one of the following:
a capability of supporting parallel Tx switching;
a capability of supporting serial Tx switching; and
a maximum number of times of switching within a preset period.

Optionally, the capability information further includes at least one of the following:
a frequency domain resource combination supporting Tx switching;
a switching period of Tx switching; and
a type of supported Tx switching.

Optionally, the frequency domain resource combination supporting Tx switching is a frequency domain resource pair, and in a case that the terminal triggers Tx switching within a frequency domain resource pair in N frequency domain resource pairs, a period for which the terminal completes Tx switching in the N frequency domain resource pairs includes one of the following:
a minimum period in N switching periods;
a maximum period in the N switching periods;
a weighted sum of the N switching periods; and
a total period of the N switching periods, where
the N switching periods are switching periods respectively corresponding to the N frequency domain resource pairs, and N is an integer greater than 1.

Optionally, in a case that transmission performed by the terminal after Tx switching is transmission on one antenna port, the period for which the terminal completes Tx switching in the N frequency domain resource pairs includes the minimum period in the N switching periods; and/or
in a case that the terminal supports parallel Tx switching between different frequency domain resources, the period for which the terminal completes Tx switching in the N frequency domain resource pairs includes the minimum period in the N switching periods.

Optionally, in a case that transmission performed by the terminal after Tx switching includes at least one of transmission on a plurality of antenna ports and transmission on a plurality of frequency domain resources, the period for which the terminal completes Tx switching in the N frequency domain resource pairs includes the maximum period in the N switching periods; and/or
in a case that the terminal supports parallel Tx switching between different frequency domain resources, the period for which the terminal completes Tx switching in the N frequency domain resource pairs includes the maximum period in the N switching periods.

Optionally, in a case that transmission performed by the terminal after Tx switching is at least one of transmission on a plurality of antenna ports and transmission on a plurality of frequency domain resources, the period for which the terminal completes Tx switching in the N frequency domain resource pairs includes the total period of the N switching periods; and/or
in a case that the terminal supports serial Tx switching between different frequency domain resources, the period for which the terminal completes Tx switching in the N frequency domain resource pairs includes the total period of the N switching periods.

Optionally, in the frequency domain resource combination supporting Tx switching, Tx switching is supported between at least two frequency domain resources.

Optionally, the switching period of Tx switching includes:
a switching period of M frequency domain resources in one or more frequency domain resource combinations supporting Tx switching, where M is a positive integer; and
the M frequency domain resources include one of the following:
a frequency domain resource on which transmission or scheduling by the terminal occurs before and/or after Tx switching;
a frequency domain resource on which transmission or scheduling by the terminal changes before and after Tx switching;
all frequency domain resources in the frequency domain resource combination supporting Tx switching;
a frequency domain resource configured through carrier aggregation in the frequency domain resource combination supporting Tx switching; and
a frequency domain resource activated through carrier aggregation in the frequency domain resource combination supporting Tx switching.

Optionally, the capability of supporting parallel Tx switching includes at least one of the following:
allowing switching periods of different Tx switching to at least partially overlap;
allowing an interval between switching periods of different Tx switching to be less than or equal to a first preset threshold;
allowing another Tx to switch or to be triggered switching after Tx switching is triggered;
allowing another Tx to switch or to be triggered switching before switched transmission starts or ends; and
allowing another Tx to switch or to be triggered switching after switched transmission starts.

Optionally, the allowing another Tx to switch or to be triggered switching after Tx switching is triggered includes:
allowing another Tx to switch or to be triggered switching within a first predetermined period after Tx switching is triggered; and/or
the allowing another Tx to switch or to be triggered switching before switched transmission starts or ends includes:
allowing another Tx to switch or to be triggered switching within a second predetermined period before switched transmission starts or ends; and/or
the allowing another Tx to switch or to be triggered switching after switched transmission starts includes:
allowing another Tx to switch or to be triggered switching within a third predetermined period after switched transmission starts.

Optionally, the capability information further includes at least one of the following:
the first predetermined period, the second predetermined period, and the third predetermined period.

Optionally, the capability of supporting serial Tx switching includes at least one of the following:
switching periods of different Tx switching do not overlap;
allowing an interval between switching periods of different Tx switching to be greater than or equal to a second preset threshold;
disallowing another Tx to trigger switching after Tx switching is triggered;
disallowing another Tx to trigger switching before switched transmission starts or ends; and
disallowing another Tx to trigger switching after switched transmission starts.

Optionally, the disallowing another Tx to trigger switching after Tx switching is triggered includes:
disallowing another Tx to trigger switching within a fourth predetermined period after Tx switching is triggered; and/or
the disallowing another Tx to trigger switching before switched transmission starts or ends includes:
disallowing another Tx to trigger switching within a fifth predetermined period before switched transmission starts or ends; and/or
the disallowing another Tx to trigger switching after switched transmission starts includes:
disallowing another Tx to trigger switching within a sixth predetermined period after switched transmission starts.

Optionally, the capability information further includes at least one of the following:
the fourth predetermined period, the fifth predetermined period, and the sixth predetermined period.

Optionally, in a case that Tx switching is triggered on X frequency domain resources,
the terminal cannot perform transmission or cannot be scheduled on a first target frequency domain resource within a switching period of the X frequency domain resources, and the first target frequency domain resource includes the X frequency domain resources or the first target frequency domain resource includes at least one of the following:
a frequency domain resource corresponding to transmission before switching;
a frequency domain resource corresponding to switched transmission;
a frequency domain resource on which transmission changes before switching; and
a frequency domain resource on which transmission changes after switching; and/or
in a case that Tx switching is triggered on X frequency domain resources,
the terminal cannot perform transmission or cannot be scheduled on a second target frequency domain resource within a switching period of the m^{th} frequency domain resource pair in the X frequency domain resources, and the second target frequency domain resource includes the m^{th} frequency domain resource pair or the second target frequency domain resource includes at least one of the following in the m^{th} frequency domain resource pair:
a frequency domain resource on which transmission changes before switching; and
a frequency domain resource on which transmission changes after switching, where
X and m are positive integers.

Optionally, that Tx switching is triggered on the X frequency domain resources includes at least one of the following:
Tx switching is simultaneously triggered on the X frequency domain resources;
Tx switching is triggered within a preset period range on the X frequency domain resources; and
a preset condition is met when Tx switching is triggered on the X frequency domain resources.

Optionally, after O times of switching, switching is allowed only after at least a seventh predetermined period elapses; or
after O times of switching, no further switching is expected within an eighth predetermined period, where
O is a positive integer.

Optionally, the seventh predetermined period or the eighth predetermined period is one slot, and a subcarrier spacing SCS corresponding to the one slot is a maximum or minimum SCS in a switching process, where the maximum or minimum SCS includes one of the following:
a maximum or minimum SCS in SCSs of carriers or bandwidth parts BWPs that participate in switching;
a maximum or minimum SCS of a band that participates in switching;
a maximum or minimum SCS in SCSs corresponding to frequency domain resources or of N bands corresponding to switching, where N is an integer greater than 1; and
a maximum or minimum SCS in SCSs of all bands, carriers, or BWPs that are configured for the terminal.

Optionally, switching that meets at least one of the following is one time of switching:
time points at which Tx switching is triggered are the same;
downlink control information DCI triggered by Tx switching is the same;
target frequency domain resources after switching are the same;
source frequency domain resources before switching are the same; and
start time points of target uplink transmission after switching are the same or within a ninth predetermined period.

Optionally, an event that meets at least one of the following is Tx switching:
an index of a frequency domain resource for transmission changes;
a number of Txs, antenna ports, layers, or resource pools for transmission changes; and
a number of frequency domain resources for transmission changes.

Optionally, the switching period of Tx switching is associated with at least one of the following:
a number of antenna ports for transmission and an index of an antenna port for transmission.

Optionally, the frequency domain resource includes one of the following:
a band, a carrier, a BWP, and a resource pool.

The foregoing communication device can improve transmission performance of the terminal.

An embodiment of this application further provides a readable storage medium. The readable storage medium stores a program or an instruction, and the program or the instruction is executed by a processor to implement the processes of the foregoing capability information reporting method or capability information receiving method embodiment, and a same technical effect can be achieved. To avoid repetition, details are not described herein again.

The processor is a processor in the terminal in the foregoing embodiment. The readable storage medium includes a computer readable storage medium, such as a computer read-only memory ROM, a random access memory RAM, a magnetic disk, or an optical disc.

An embodiment of this application further provides a chip. The chip includes a processor and a communication interface, the communication interface is coupled to the processor, and the processor is configured to run a program or an instruction to implement the processes of the foregoing capability information reporting method or capability information receiving method embodiment, and a same technical effect can be achieved. To avoid repetition, details are not described herein again.

It should be understood that the chip mentioned in this embodiment of this application may also be referred to as a system-level chip, a system chip, a chip system, or an on-chip system chip.

An embodiment of this application further provides a computer program product. The computer program product is stored in a storage medium, and the computer program product is executed by at least one processor to implement the processes of the foregoing capability information reporting method or capability information receiving method embodiment, and a same technical effect can be achieved. To avoid repetition, details are not described herein again.

An embodiment of this application further provides a capability information transmission system, including a terminal and a communication device. The terminal may be configured to perform the steps of the foregoing capability information reporting method, and the communication device may be configured to perform the steps of the foregoing capability information receiving method.

It should be noted that, in this specification, the terms “include”, “comprise”, or their any other variant are intended to cover a non-exclusive inclusion, so that a process, a method, an article, or an apparatus that includes a list of elements not only includes those elements but also includes other elements which are not expressly listed, or further includes elements inherent to such process, method, article, or apparatus. An element preceded by “includes a . . . ” does not, without more constraints, preclude the presence of additional identical elements in the process, method, article, or apparatus that includes the element. In addition, it should be noted that the scope of the method and the apparatus in the embodiments of this application is not limited to performing functions in an illustrated or discussed sequence, and may further include performing functions in a basically simultaneous manner or in a reverse sequence according to the functions concerned. For example, the described method may be performed in an order different from that described, and the steps may be added, omitted, or combined. In addition, features described with reference to some examples may be combined in other examples.

Based on the foregoing descriptions of the embodiments, a person skilled in the art may clearly understand that the method in the foregoing embodiment may be implemented by software in addition to a necessary universal hardware platform or by hardware only. In most circumstances, the former is a preferred implementation manner. Based on such an understanding, the technical solutions of this application essentially or the part contributing to the prior art may be implemented in a form of a computer software product. The computer software product is stored in a storage medium (for example, a ROM/RAM, a floppy disk, or an optical disc), and includes several instructions for instructing a terminal (which may be a mobile phone, a computer, a server, an air conditioner, a network device, or the like) to perform the methods described in the embodiments of this application.

The embodiments of this application are described above with reference to the accompanying drawings, but this application is not limited to the above specific implementations, and the above specific implementations are merely illustrative but not restrictive. Under the enlightenment of this application, a person of ordinary skill in the art can make many forms without departing from the purpose of this application and the protection scope of the claims, all of which fall within the protection of this application.

What is claimed is:

1. A capability information reporting method, comprising:
reporting, by a terminal, capability information related to Tx switching, wherein the capability information comprises at least one of the following:
a capability of supporting parallel Tx switching;
a capability of supporting serial Tx switching; or
a maximum number of times of switching within a preset period.

2. The method according to claim 1, wherein the capability information further comprises at least one of the following:
a frequency domain resource combination supporting Tx switching;
a switching period of Tx switching; or
a type of supported Tx switching.

3. The method according to claim 2, wherein the frequency domain resource combination supporting Tx switching is a frequency domain resource pair, and in a case that the terminal triggers Tx switching within a frequency domain resource pair in N frequency domain resource pairs, a period for which the terminal completes Tx switching in the N frequency domain resource pairs comprises one of the following:
a minimum period in N switching periods;
a maximum period of the N switching periods;
a weighted sum of the N switching periods; or
a total period of the N switching periods, wherein
the N switching periods are switching periods respectively corresponding to the N frequency domain resource pairs, and N is an integer greater than 1.

4. The method according to claim 3, wherein in a case that transmission performed by the terminal after Tx switching is transmission on one antenna port, the period for which the terminal completes Tx switching in the N frequency domain resource pairs comprises the minimum period in the N switching periods; and/or
in a case that the terminal supports parallel Tx switching between different frequency domain resources, the period for which the terminal completes Tx switching in the N frequency domain resource pairs comprises the minimum period in the N switching periods.

5. The method according to claim 3, wherein in a case that transmission performed by the terminal after Tx switching comprises at least one of transmission on a plurality of antenna ports and transmission on a plurality of frequency domain resources, the period for which the terminal completes Tx switching in the N frequency domain resource pairs comprises the maximum period in the N switching periods; and/or
in a case that the terminal supports parallel Tx switching between different frequency domain resources, the period for which the terminal completes Tx switching in the N frequency domain resource pairs comprises the maximum period in the N switching periods.

6. The method according to claim 2, wherein in the frequency domain resource combination supporting Tx switching, Tx switching is supported between at least two frequency domain resources.

7. The method according to claim 2, wherein the switching period of Tx switching comprises:
a switching period of M frequency domain resources in one or more frequency domain resource combinations supporting Tx switching, wherein M is a positive integer; and
the M frequency domain resources comprise one of the following:
a frequency domain resource on which the terminal has transmission or scheduling before and/or after Tx switching;
a frequency domain resource on which transmission or scheduling by the terminal changes before and after Tx switching;
all frequency domain resources in the frequency domain resource combination supporting Tx switching;
a frequency domain resource configured through carrier aggregation in the frequency domain resource combination supporting Tx switching; or
a frequency domain resource activated through carrier aggregation in the frequency domain resource combination supporting Tx switching.

8. The method according to claim 1, wherein the capability of supporting parallel Tx switching comprises at least one of the following:
allowing switching periods of different Tx switching to at least partially overlap;
allowing an interval between switching periods of different Tx switching to be less than or equal to a first preset threshold;
allowing another Tx to switch or to be triggered switching after Tx switching is triggered;
allowing another Tx to switch or to be triggered switching before switched transmission starts or ends; or
allowing another Tx to switch or to be triggered switching after switched transmission starts;
wherein
the allowing another Tx to switch or to be triggered switching after Tx switching is triggered comprises:
allowing another Tx to switch or to be triggered switching within a first predetermined period after Tx switching is triggered; and/or
the allowing another Tx to switch or to be triggered switching before switched transmission starts or ends comprises:
allowing another Tx to switch or to be triggered switching within a second predetermined period before switched transmission starts or ends; and/or
the allowing another Tx to switch or to be triggered switching after switched transmission starts comprises:
allowing another Tx to switch or to be triggered switching within a third predetermined period after switched transmission starts;
wherein the capability information further comprises at least one of the following:
the first predetermined period, the second predetermined period, or the third predetermined period.

9. The method according to claim 1, wherein the capability of supporting serial Tx switching comprises at least one of the following:
switching periods of different Tx switching do not overlap;
allowing an interval between switching periods of different Tx switching to be greater than or equal to a second preset threshold;
disallowing another Tx to switch or to be triggered switching after Tx switching is triggered;
disallowing another Tx to switch or to be triggered switching before switched transmission starts or ends; or
disallowing another Tx to switch or to be triggered switching after switched transmission starts;
wherein
the disallowing another Tx to switch or to be triggered switching after Tx switching is triggered comprises:
disallowing another Tx to switch or to be triggered switching within a fourth predetermined period after Tx switching is triggered; and/or
the disallowing another Tx to switch or to be triggered switching before switched transmission starts or ends comprises:
disallowing another Tx to switch or to be triggered switching within a fifth predetermined period before switched transmission starts or ends; and/or
the disallowing another Tx to switch or to be triggered switching after switched transmission starts comprises:
disallowing another Tx to switch or to be triggered switching within a sixth predetermined period after switched transmission starts;
wherein the capability information further comprises at least one of the following:
the fourth predetermined period, the fifth predetermined period, or the sixth predetermined period.

10. The method according to claim 1, wherein in a case that Tx switching is triggered on X frequency domain resources,
the terminal cannot perform transmission or cannot be scheduled on a first target frequency domain resource within a switching period of the X frequency domain resources, and the first target frequency domain resource comprises the X frequency domain resources or the first target frequency domain resource comprises at least one of the following:
a frequency domain resource corresponding to transmission before switching;
a frequency domain resource corresponding to switched transmission;
a frequency domain resource on which transmission changes before switching; or
a frequency domain resource on which transmission changes after switching; and/or
in a case that Tx switching is triggered on X frequency domain resources,
the terminal cannot perform transmission or cannot be scheduled on a second target frequency domain resource within a switching period of the m^{th} frequency domain resource pair in the X frequency domain resources, and the second target frequency domain resource comprises the m^{th} frequency domain resource pair or the second target frequency domain resource comprises at least one of the following in the m^{th} frequency domain resource pair:
a frequency domain resource on which transmission changes before switching; and
a frequency domain resource on which transmission changes after switching, wherein
X and m are positive integers.

11. The method according to claim 10, wherein that Tx switching is triggered on the X frequency domain resources comprises at least one of the following:
Tx switching is simultaneously triggered on the X frequency domain resources;
Tx switching is triggered within a preset period range on the X frequency domain resources; or
a preset condition is met when Tx switching is triggered on the X frequency domain resources.

12. The method according to claim 1, wherein after O times of switching, switching is allowed only after at least a seventh predetermined period elapses; or
after O times of switching, no further switching is expected within an eighth predetermined period, wherein
O is a positive integer.

13. The method according to claim 12, wherein the seventh predetermined period or the eighth predetermined period is one slot, and a subcarrier spacing (SCS) corresponding to the one slot is a maximum or minimum SCS in a switching process, wherein the maximum or minimum SCS comprises one of the following:
a maximum or minimum SCS in SCSs of carriers or bandwidth parts (BWPs) that participate in switching;
a maximum or minimum SCS of a band that participates in switching;
a maximum or minimum SCS in SCSs corresponding to frequency domain resources or of N bands corresponding to switching, wherein N is an integer greater than 1; or
a maximum or minimum SCS in SCSs of all bands, carriers, or BWPs that are configured for the terminal.

14. The method according to claim 1, wherein switching that meets at least one of the following is one time of switching:
time points at which Tx switching is triggered are the same;
downlink control information (DCI) triggered by Tx switching is the same;
target frequency domain resources after switching are the same;
source frequency domain resources before switching are the same; or
start time points of target uplink transmission after switching are the same or within a ninth predetermined period.

15. The method according to claim 1, wherein an event that meets at least one of the following is Tx switching:
an index of a frequency domain resource for transmission changes;
a number of Txs, antenna ports, layers, or resource pools for transmission changes; or
a number of frequency domain resources for transmission changes.

16. The method according to claim 2, wherein the switching period of Tx switching is associated with at least one of the following:
a number of antenna ports for transmission or an index of an antenna port for transmission.

17. The method according to claim 2, wherein the frequency domain resource comprises one of the following:
a band, a carrier, a BWP, or a resource pool.

18. A capability information receiving method, comprising:
receiving, by a communication device, capability information that is related to Tx switching and that is reported by a terminal, wherein the capability information comprises at least one of the following:
a capability of supporting parallel Tx switching;
a capability of supporting serial Tx switching; or
a maximum number of times of switching within a preset period.

19. A terminal, comprising a processor and a memory, wherein the memory stores a program or an instruction that can be run on the processor, wherein the program or the instruction, when executed by the processor, causes the terminal to perform:
reporting capability information related to Tx switching, wherein the capability information comprises at least one of the following:
a capability of supporting parallel Tx switching;
a capability of supporting serial Tx switching; or
a maximum number of times of switching within a preset period.

20. A communication device, comprising a processor and a memory, wherein the memory stores a program or an instruction that can be run on the processor, and the program or the instruction is executed by the processor to implement the steps of the capability information receiving method according to claim 18.
